(19) United States
(12) Patent Application Publication
(10) Pub. No.: US 2012/0066410 A1
(43) Pub. Date: Mar. 15, 2012

(54) DATA STRUCTURE, METHOD AND SYSTEM FOR ADDRESS LOOKUP

(75) Inventors: George Stefanakis, Delft (NL); Ioannis Sourdis, Delft (NL); Georgi Nedeltchev Gaydadjiev, Delft (NL); Ruben De Smet, Delft (NL)

(73) Assignee: TECHNISCHE UNIVERSITEIT DELFT, Delft (NL)

(21) Appl. No.: 13/265,663

(22) PCT Filed: Apr. 26, 2010
(86) PCT No.: PCT/NL2010/050231

§ 371 Date: Nov. 23, 2011

(30) Foreign Application Priority Data
Apr. 24, 2009 (NL) 2002799

(51) Int. Cl. G06F 15/16

(52) U.S. Cl. 709/245

(57) ABSTRACT

Method and computer system for constructing a decision tree for use in address lookup of a requested address in an address space. The address space is arranged as a set of basic address ranges. Each basic address range is defined by a lower and an upper bound address, and an address in the address space is represented by a predetermined number of bits.

### TECHNICAL FIELD

The present invention relates to a method for address lookup of a requested address in an address space by using a decision tree. Also, the present invention relates to a computer system for address lookup of a requested address in an address space by using a decision tree. Furthermore, the present invention relates to a computer program for address lookup of a requested address in an address space by using a decision tree.

### BACKGROUND OF THE INVENTION

The present invention relates to a data structure representing a set of basic address ranges and a method of searching the structure. Also, the present invention relates to a system for address lookup.

Address lookup is an essential function that finds application in several domains: primarily in IP (internet protocol) lookup and routing and packet classification, but also in interprocessor communication.

Internet backbone routers use packet's destination address and perform address lookup to determine the next hop of a packet. Each router may contain hundreds of thousands entries in lookup tables and may be required to perform millions of lookups per second. The rapid growth of internet traffic and the growing size of routing-tables make more difficult to keep pace with the increasing need for faster processing rates. In addition, the use of IPv6 128-bit addresses demands lookup strategy solutions scalable in the address width. IPv6 growth increased 300% in the past two years and coupled with the IPv4 exhaustion poses the need for solutions scalable with the address width.

Packet classification requires multi-Gbps performance as well as having multiple fields to lookup and possibly fewer table entries.

In the smaller scale of interprocessor communication, the progressive translation of virtual to physical addresses may require significantly smaller routing-tables, but the lookup time constraints are tighter as communication latency is critical for the performance of a multicore system.

Given an address space [0, 2^{W}) and k unique addresses (address bounds) Aᵢ, where 0<Aᵢ<2ⁿ-1 and i=1, 2, . . . , k, that define k+1 variable-size basic address ranges, then address lookup determines the basic address range an incoming requested address A_{IN} belongs to.

In general, there are many challenging issues that need to be addressed when performing address lookup. Performance (i.e. fast lookup and high throughput) is probably the main objective for such algorithms. In many cases (e.g., IP lookup, Packet Classification), the memory size needed during lookup is also important and often determines performance (memory access delay). In addition, the memory bandwidth is limited and its efficient utilization may directly affect performance. As the routing tables get bigger performance needs to scale well in the number of entries (i.e., number of address ranges), while moving from IPv4 to IPv6 indicates that performance scaling in the address width (W) is also necessary. Finally, the time to generate the “configuration” of the lookup table (i.e., memory contents) for a given set of entries as well as the time for adapting a table due to incremental updates is also important for many applications.

Although a plethora of algorithms has been proposed, several of the above challenges remain.

Various algorithms have been proposed for address lookup. They have been summarized in several surveys such as the ones by Gupta and McKeown in “Algorithms for packet classification,” IEEE Network, vol. 15, pp. 24-32, March/April 2001, and by Taylor in “Survey and taxonomy of packet classification techniques”, ACM Comput. Surv., vol. 37, no. 3, pp. 238-275, 2005 which focus on packet classification (lookup in multiple fields), or the one of Ruiz-Sanchez et al. that emphasizes more the algorithmic side of the various approaches in “Survey and taxonomy of IP address lookup algorithms”, IEEE Network, vol. 15, pp. 8-23, March/April 2001.

A complete list and analysis of previously proposed algorithms of address lookup can be found in the above surveys.

FIG. 1 shows an address space which comprises a set of basic address ranges. The address space may for example relate to an IP (Internet Protocol) address space. The set of basic address ranges can be expressed as intervals 101 defined by address bounds, where the complete bit patterns of addresses can be compared to perform a lookup, or can be expressed as prefixes 102 out of which the longest matching one should be reported (Longest Prefix Match). An example set of eight address ranges R1, R2, R3, R4, R5, R6, R7, R6′-expressed as interval and prefixes—is shown in FIG. 1 for a 5-bits address space (W=5) running from 00000 to 11111. Note that although the prefix 0* 103 would normally define the interval [00000, 10000) it actually defines only part of it, the interval (and the basic address range) [00000, 00110) 104. This is because for the remaining address range [00110, 10000) there are longer prefixes which define the basic address range (prefixes 0011*, 0100*, 0101*, 011*) 105, 106, 107.

Ruiz-Sanchez et al. indicate that address lookup involves searching in two dimensions: length or value. They categorize existing approaches according to the dimension the search is based on, namely as “search on length” or “search on values”.

A method known as “Tries” can be considered a “search on length” approach as Tries perform a sequential search on the length dimension, matching at step n prefixes of length n.

Improvements on the basic Trie structure may include binary search on length instead of sequential, path compression (collapsing one-way branch nodes), and fixed or variable-stride multibit tries. The best known trie-based structure for address lookup is the one using Tree-bitmap in Eatherton, W., Varghese, G., and Dittia, Z. “Tree bitmap: hardware/software IP lookups with incremental updates”, SIGCOMM Comput. Commun. Rev. 34, 2 (April 2004), 97-122, and in Eatherton; William N., Dittia; Zubin D. “Tree bitmap data structures and their use in performing lookup operations” U.S. Pat. No. 7,249,149.

FIG. 2 depicts an example of a Trie structure. In the horizontal direction the basic address ranges R1, R2, R3, R4, R5, R6 and R7 of 101 are indicated 201. In the vertical direction the branches of the decision tree are indicated 202-203. The course along the decision tree is indicated by arrows labeled with ‘0’ 203 for a bit comparison where the bit is ‘0’ and arrows labeled with ‘1’ 202 for a bit comparison where the bit is ‘1’.

It can be observed that the resulted decision tree can be significantly unbalanced. As indicated by Ruiz-Sanchez it is difficult to control the height of a Trie which does not scale in the address width as any improvement of it (e.g. Tree Bitmaps). Furthermore, the memory requirements of the Tries are relatively high. Multibit tries improve on the decision tree height but not the scalability, while they exponentially increase their memory consumption.

FIG. 3 illustrates a typical “search on values” approach by a prior art method known as “Range Tree”. In the horizontal direction the basic address ranges R1, R2, R3, R4, R5, R6, R7 and R6′ of 101 are indicated as 301. In FIG. 3 at each level one or more values of the full address (address bounds) 302 need to be stored in a node and compared with the incoming requested address A_{IN}. The label L 303 on each branch indicates ‘has value less than’, the label E indicates ‘has value equal to’, the label G 614 indicates ‘has greater than’ and label GE 304 indicates ‘has value greater than or equal to’.

Prior art Range Trees avoid the length dimension storing and performing comparisons on the expanded prefixes (full/complete address bounds). They perform one or many address comparisons, at each comparison step creating a balanced decision tree. They need to store the complete addresses to be compared at each stage and therefore consume considerable memory size.

FIG. 4 depicts an example of a prior art Multiway Range Tree structure. Multiway Range Trees perform multiple concurrent comparisons on full addresses (address bounds), however their requirement to read at every step multiple addresses limits their number of ways to the available memory bandwidth and reduces their scalability with respect to the address width.

It is helpful to understand the background of the prior art Range Tree method as a closest known method for searching tree structures of data.

Given an address space [0, 2^{W}) and k unique address bounds Aᵢ, where 0<Aᵢ<2ⁿ-1 and i=1, 2, . . . , k, that define k+1 basic address ranges, then an address lookup is to determine the basic address range an incoming address A_{IN} belongs to.

A basic address range 401, 405 is defined by its lower and upper bound address (endpoints) or by a prefix.

A prior art Range Tree is a tree structure organized for searching.

A Range Tree node 406, 407, 410, 411 is a portion of the tree structure which stores k address bounds (node addresses) and performs k (one or more) comparisons between the incoming address and the k address bounds 402. These comparisons define k+1 disjoint address ranges (branch address ranges) each associated with a branch of the node 403, 404, 409.

A root range tree node 407 maps to the entire address space.

Any other node 406, 410, 411 maps to the node address range associated with its parent branch (parent branch address range).

A multiway Range Tree is a Range Tree which can perform more than one comparison at a single node.

A leaf node of the Range Tree 408 maps to a basic address range.

In general, a multiway Range Tree node maps to an address range of the address space. The union of the address ranges of (1) the nodes in a single tree level and (2) the leaf nodes of previous tree levels is the entire address space. The union of the children node address ranges is the address range of their parent node.

Prefixes that define address ranges can be stored in a Range Tree by storing at each node the longest prefix that entirely contains the address interval the node maps to, when the parent node address range is not entirely contained in the prefix. In addition, for update reasons each address bound (node address) stored in the data structure stores also the number of prefixes a bound of which falls on this address bound.

In general, the method of Tries performs exact match in parts of addresses, while the prior art method of Range Trees performs comparisons of full addresses.

A generic view of a multiway Range Tree node 501 is illustrated in FIG. 5. The node is retrieved when the incoming address A_{IN} belongs to the address range in which the node maps to [Nₐ,N_{b}) 502-503. The root node of a multiway range tree maps to the entire address space [0, 2^{W}) where W is the address width. The node stores k unique address bounds A₁, A₂, . . . , Aᵢ, . . . , Aₖ, (also denoted as node addresses) which define k+1 address ranges R₁, R₂, . . . , Rₖ₊₁ 520-523. Aᵢ∈ [Nₐ,N_{b}), ∀ i∈ Natural numbers and i≦k, such that R₁=[Nₐ,A₁), . . . , Rᵢ=[Aᵢ₋₁,Aᵢ), . . . Rₖ₊₁=[Aₖ,N_{b}). Then an incoming address A_{IN}∈ [Nₐ,N_{b}) needs to be compared against the addresses Aᵢ in order to determine the address range Rᵢ to which it belongs to.

FIG. 4 illustrates an example of a Multiway Range Tree that stores a set of basic address ranges. The root node 407 maps to the entire address space [0, 100000) and stores and compares two address bounds “01010” and “10000” 402 against the incoming address A_{IN}. If A_{IN}<01010 the branch 403 to leftmost child node 411 is followed which maps to [00000, 01010), if 01010≦A_{IN}<10000 then the branch 409 to the middle child node 410 is followed which maps to [01010,10000), and when A_{IN}≧10000, the rightmost branch 404 is taken to the node 406 which maps to the [10000, 100000). The above numbers are in binary encoding. Similarly, the leftmost child 411 node compares addresses “00110” and “01000”. If A_{IN}<00110 the branch to the leftmost interval R1 408 is followed which maps to [00000, 00110) 401, if 00110≦A_{IN}<01000 then the branch to the interval R2 is followed which maps to [01010, 10000), and when A_{IN}≧10000, the branch to the R3 is followed which maps to [10000, 100000).

It is an object of the present invention to provide a method that allows a more efficient address lookup.

The object is achieved by a method for constructing a decision tree for use in address lookup of a requested address in an address space,
the address space being arranged as a set of basic address ranges,
each basic address range being defined by a lower and an upper bound address;
an address in the address space being represented by a predetermined number of bits; the method comprising:
   arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits,
the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step, said all other address parts not being either the at least one common address part or the at least one omissible address part.

In an embodiment, the method comprises:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes of the decision tree.

The present invention further relates to a computer system for constructing a decision tree for use in address lookup of a requested address in an address space, the address space being arranged as a set of basic address ranges,
each basic address range being defined by a lower and an upper bound address;
an address in the address space being represented by a predetermined number of bits the computer system comprising a memory and a processor, the processor being coupled to the memory, wherein the processor is arranged for carrying out a method for constructing the decision tree for use in address lookup of the requested address in the address space, comprising:
   arranging the decision tree for determining a specific basic address range from the set of basic address ranges to which the requested address belongs,
the decision tree comprising at least one level, the at least one level comprising at least one node;

the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits,
the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step, said all other address parts not being either the at least one common address part or the at least one omissible address part.

Moreover, the present invention relates to a computer program on a computer-readable medium to be loaded by a computer system as described above, for constructing a decision tree for use in address lookup of a requested address in an address space,
the address space being arranged as a set of basic address ranges,
each basic address range being defined by a lower and an upper bound address;
an address in the address space being represented by a predetermined number of bits;
the computer system comprising a memory and a processor, the processor being coupled to the memory, wherein the computer program product after being loaded allows the processor to carry out:
   arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits,
the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step, said all other address parts not being either the at least one common address part or the at least one omissible address part.

Additionally, the present invention relates to a computer system for address lookup of a requested address in an address space by using a decision tree, the decision tree being constructed according to the method as described above, the computer system comprising a memory and a processor, the processor being coupled to the memory, wherein the processor is arranged for carrying out:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes.
Further embodiments are defined by the dependent claims as appended.

While the invention has been disclosed with specific reference to telecommunication applications, the data structure and search method of this invention promotes rapid search of any database that defines address ranges in the form of address intervals or address prefixes. The method and system is well suited to implementation in computer hardware, is scalable to the address width and the number of stored address ranges, provides a compact storage, and can be applied to a pressing problem in the design of Internet multiservice routers.

The data structure and the search method are particularly advantageous for implementation in digital computer hardware. The primary applications of current interest are to semiconductor integrated circuits used for IP-lookup, packet-classification, multiservice Internet Routers. However the technique may be useful in a variety of applications involving data that need to be prioritized or wherein structure in the data needs to be determined and then to be classified. As a result of the address lookup, action on data can be taken more quickly and efficiently.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically shows an example of address regions within an address space;

FIG. 2 schematically shows a decision tree in accordance with a Trie method from the prior art;

FIG. 3 schematically shows a decision tree in accordance with the Range Tree method from the prior art;

FIG. 4 schematically shows a decision tree in accordance with the multiway Range Tree method from the prior art;

FIG. 5 schematically shows a Range Trie node that maps to a range tree node;

FIG. 6A schematically shows a decision tree in accordance with a method of the invention;

FIG. 6B schematically shows a decision tree node in accordance with a method of the invention;

FIG. 6C schematically shows a decision tree node in accordance with a method of the invention;

FIG. 7A shows a diagram of a Range Trie, according to the invention;

FIG. 7B shows a diagram of the Range Trie after an annotation operation with extra leaf nodes and pointers;

FIG. 8 is a diagram showing the arrangement of the annotated Range Trie nodes in the memory hierarchy, according to the invention;

FIG. 9 is a graphical representation of a Range Trie node and the respective node data structure to be stored in the memory hierarchy, according to the invention;

FIG. 10 is a block diagram depicting the functional units of the invention and their interconnection, according to the invention;

FIG. 11A is a block diagram of the combinational logic of a single 32-bit comparator, according to the invention;

FIG. 11B is a block diagram of the combinational logic that implements the next range offset unit, according to the invention;

FIG. 12A schematically shows a functional block diagram of a further computer system arranged for carrying out a method according to the present invention;

FIG. 12B schematically shows a functional block diagram of a further computer system arranged in a pipeline fashion for carrying out a method according to the present invention;

FIG. 13 schematically shows the block diagram of a system arranged for carrying out a method according to the present invention.

### DESCRIPTION OF EMBODIMENTS

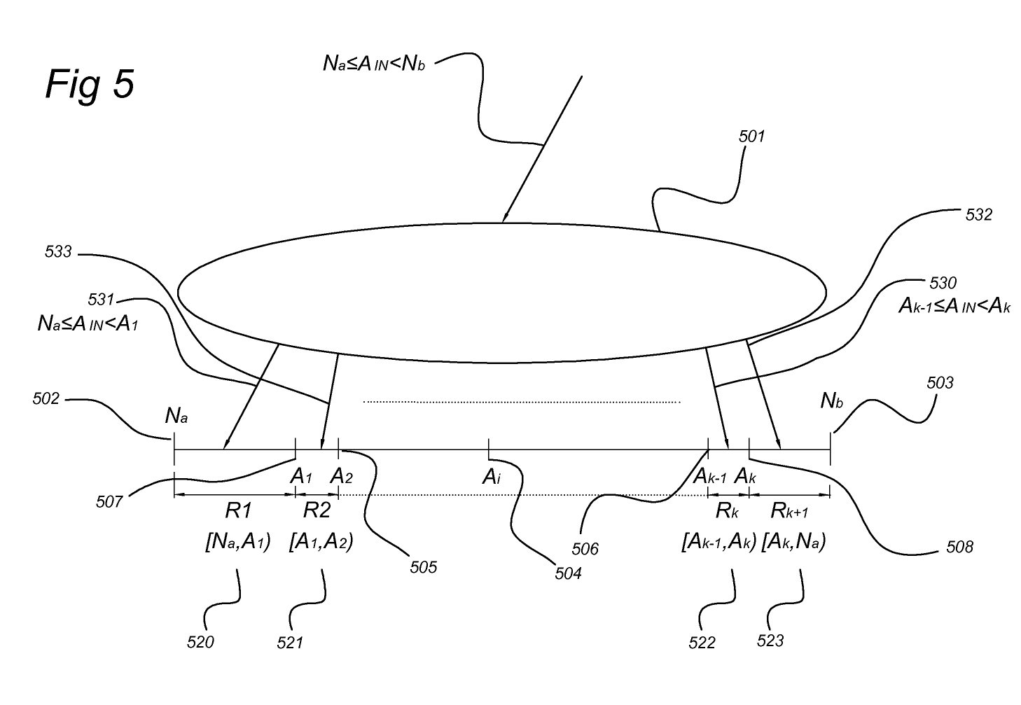

The method according to the present invention receives a requested incoming address A_{IN} and determines a basic address range R1 . . . R7 the requested address A_{IN} belongs to. The external characteristics of a Range Trie node match one to one with the external characteristics of a prior art Range Tree node. FIG. 5 schematically shows a Range Trie node that maps to a Range tree node.

Thus FIG. 5, can be used to exemplify the external characteristics of both a Range Trie node and a prior art Range Tree. The external characteristics are: 1) the address range a node maps to determined by the node low and upper bounds 502, 503, 2) the branches 530, 531, 532, 533 of the node and 3) the branch address ranges 520, 521, 522, 523 a branch 531, 533, 530, 532 points to respectively, address ranges determined by a number of address bounds (also denoted as node addresses) 507, 505, 504, 506, 508 and the node bounds (the lower and upper node bound address) 502, 503.

The difference between the method according to the present invention and the Range Tree method is that (1) different data are stored in a node and (2) different computations are required to determine the branch to be taken, based on the node information and the incoming address.

Starting from the first level node of the decision tree, according to the present invention the requested incoming address is processed in a node. Based on the requested incoming address, the data stored in a node and the node computations, the node branch to be taken is determined. This repeats until reaching a leaf node of the decision tree and thus the address range the requested incoming address belongs to.

The method according to the present invention improves on the prior art multiway Range Tree method in the following ways:

Given a maximum amount of data to be stored per tree node, possibly defined by the bandwidth of a computer-readable medium, the method increases the number of address bounds stored in a node. This can be done as explained further in the description of the specific embodiments by sharing and omitting parts of address bounds and optionally in addition by compressing the address bounds stored in a node using a compression technique.

Consequently, the method increases the number of address bounds stored in a node, and thus the branches available in the node. In so doing, the number of levels of the decision tree is reduced for a given number of basic address ranges to be stored in the decision tree, and for a given amount of data stored per node.

Subsequently, given a requested incoming address a node needs to perform a number of computations to determine the correct branch to be taken based on the data that correspond to the node. The computations can be either (1) decompressing the data stored in the node to retrieve the original address bounds and subsequently perform comparisons between the requested incoming address and the address bounds, or (2) as described below perform computations directly to the data stored in the node without decompressing. The latter embodiment involves an address alignment operation, and comparisons in parts of addresses.

We consider as a generic description of the method according to the present invention reducing the number of address bounds bits required to store in a node by: (1) sharing common address parts of address bounds, (2) omitting omissible address parts, and optionally (3) in addition further compressing the data to be stored in a node of the decision tree; subsequently, read the compressed address parts and perform computations using as input the requested incoming address A_{IN} and the data of the node. Computations may include among others decompressing the address parts stored in the node and performing comparisons in the address parts of the address bounds.

We describe henceforth in detail an embodiment, which is one of many alternative designs or rapid address lookup that employs the Range Trie method of the present invention. It is however, an excellent balance between simplicity and speed. Some further embodiments are briefly described at the end of the document and involve compressing and decompressing address bounds stored in a node and subsequently performing comparisons between the requested incoming address and the address bounds.

One specific embodiment of the method of the present invention is arranged in addition to (1) share common address parts (of the node addresses/address bounds) that are compared in parallel in the same node; (2) to omit parts of the address bounds that are not required for the comparisons; and (3) to align the address bounds and requested incoming address in order to increase the address parts to be omitted.

The address bounds (node addresses) that define address ranges may be placed sparser or denser in the address space creating longer or sorter address ranges, respectively. Intuitively, comparisons of fewer address bits may be sufficient for sparser areas in the address space, while denser areas need better precision but may have long common prefixes and even suffixes that can be shared. The above can be performed keeping the resulted decision tree balanced as well as exploiting sharing and hence improving memory bandwidth utilization. Furthermore, the method allows a scalability in terms of performance as the address width increases and as routing table size grows.

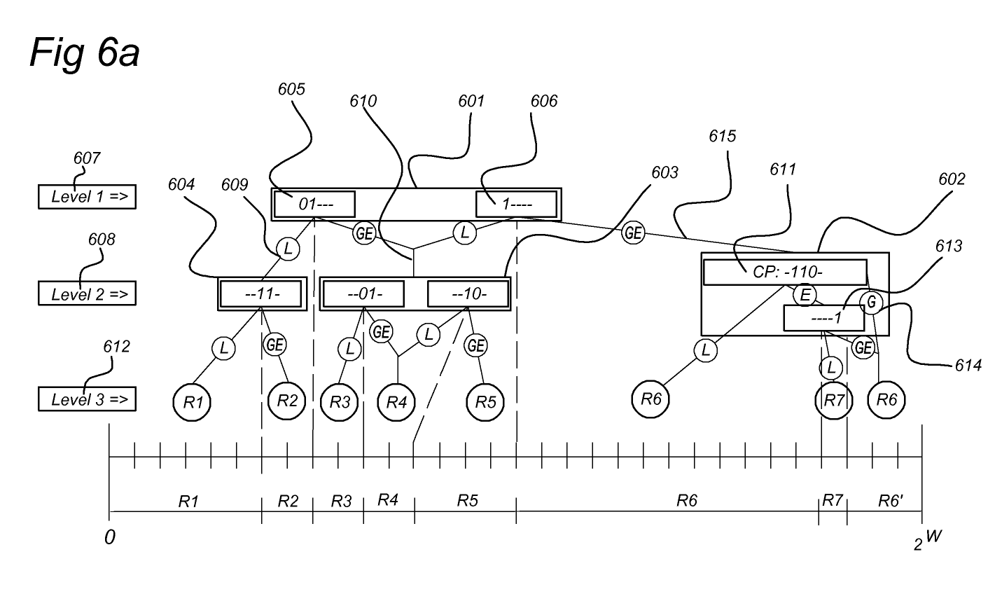

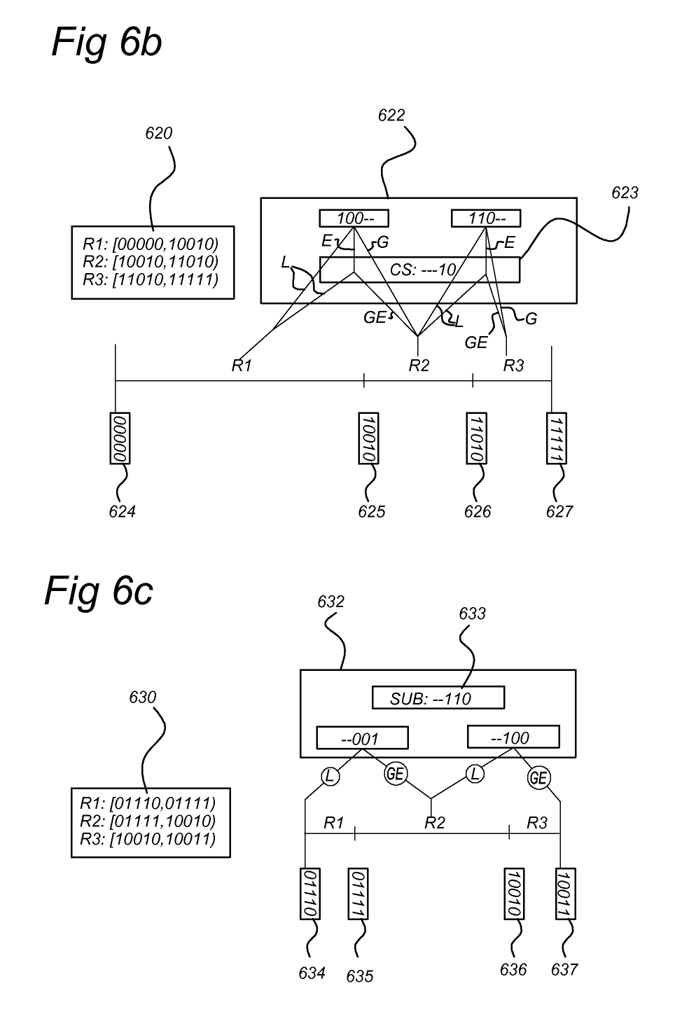

To illustrate, FIG. 6A shows a multi-way decision tree in accordance with a method of the present invention. The decision tree comprises a plurality of nodes 601, 602, 603, 604 at a number of levels in the tree. A node in a higher level may branch to a number of nodes in a level below the higher level. The node in the higher level is the parent of the (children) nodes in the level below the higher level.

The multi-way decision tree may at some level be binary, but can also have more than two branches at a single level in the tree.

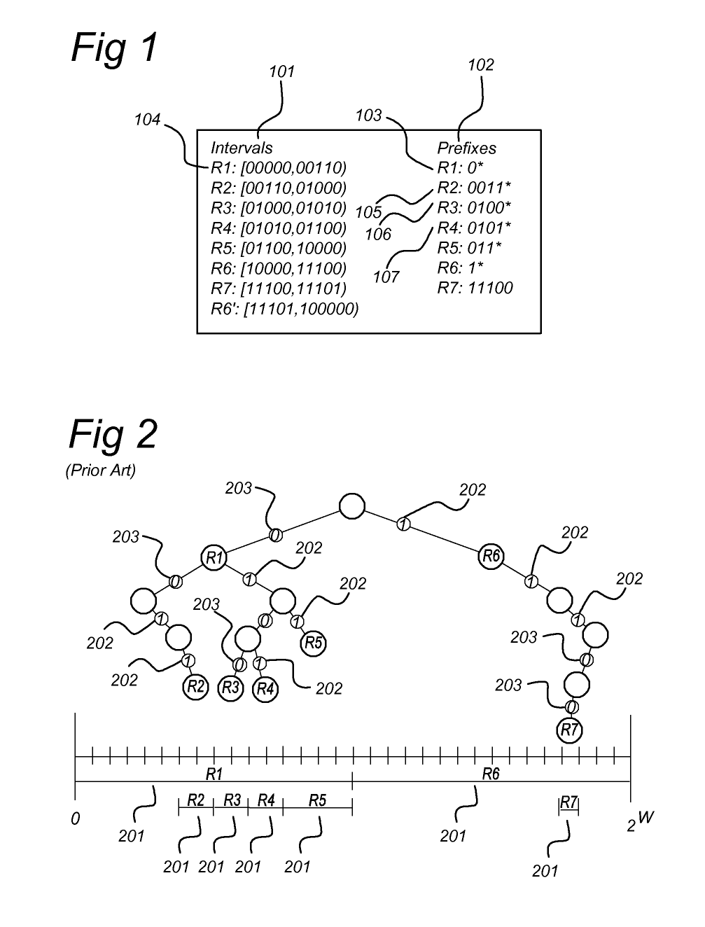

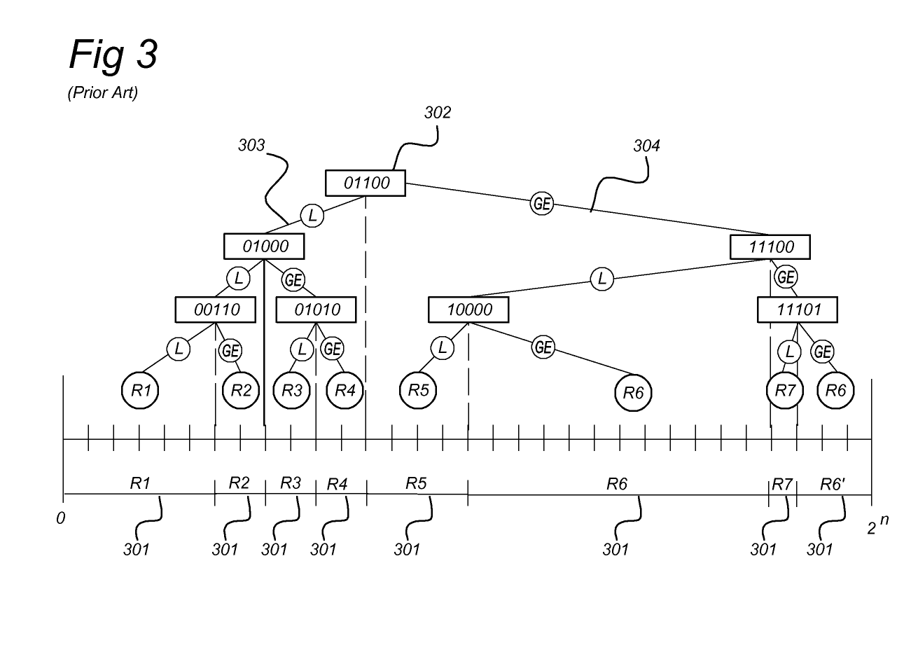

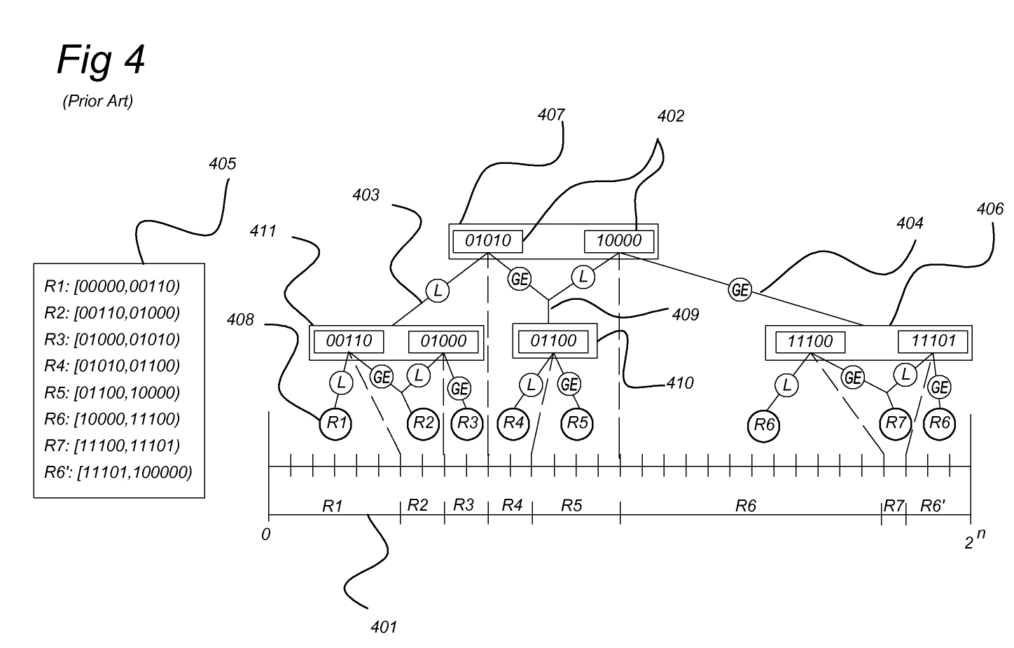

Again, the basic address ranges as defined in FIG. 1 are used here. As FIG. 6A illustrates, the method of the present invention increases the number of branches at the decision tree while comparing fewer address bits. In the example of FIG. 6A the available memory bandwidth of 5 bits is assumed equal to the one of the prior art Range Tree method shown in FIG. 3.

To illustrate the method of the present invention, in a first iteration, at the root node 601 at level 1 607, the two most significant bits of incoming address A_{IN} are compared with the parts of address bounds stored at the root node which are the two most significant bits “01---38 605 and the most significant bit “1----” 606. Less significant address bounds bits are omitted (indicated by ‘-’). This comparison is the equivalent of comparing the complete address bounds “01000” and “10000” as if it would be done in a prior art Range Tree structure.

In a second iteration at the level 2 608 and after taking the middle branch 610 from the root node 601, it would normally compare the address bounds 01010″ and “01100”. However, it is not needed to store and compare the two most significant bits since after the first iteration it is known that the incoming address is “01xxx”, with x being an undefined bit value. Also the least significant bit of the address bounds to be compared is omitted because its value is “0”.

Similarly, after taking the right branch 615 from the root level it is known that the most significant bit is “1xxxx”. Then, at the level 2 608, the two address bounds “11100” and “11101” to be compared have a common prefix Aᵢ^{CP} (“-110-”) 611 which is shared and thus stored only once in the node and compared separately. The decision of that node 602 is based on the outcome of the common prefix Aᵢ^{CP} comparison and (if needed) the comparison of the least significant bit indicated at the same node 602 as ‘----1’ 613.

As illustrated by this example, the method of the present invention results in a well balanced decision tree which is less deep than the one of the prior art Range Tree using less memory bandwidth.

Two additional ways of reducing the amount of data stored in a node per address bound are illustrated in the two examples below. That is the address alignment property of the method and the sharing of common address suffixes property of the method.

FIG. 6B illustrates an example of a Range Trie node 622 representing the set 620 of address ranges using the Range Trie method according to the present invention. The node illustrates an example of sharing common suffix of address bounds. This node represents two address bounds “10010” 625 and “11010” 626 which have two bits of common suffix “10”. The first three bits of A_{IN} are compared against the three bits of prefix of the addresses' bounds 625, 626 “100” and “110”. If there is not an exact match between the A_{IN} 3-bit prefix and the address bounds 3-bit prefixes, then the matching address range is identified. If there is an exact match of A_{IN} with one of the two prefixes of the address bounds, then the common addresses' bound suffix 623 is to be compared to the suffix of A_{IN}. In this example, the last two bits of the incoming address will be compared against “10”. The basic address range is identified depending on the result of the common suffix comparison and the match that occurred just before. The advantage of the present invention in the above example is in sharing the common suffix and thus storing it, reading it and comparing it only once.

FIG. 6C illustrates an example of a Range Trie node 632 representing the set 630 of address ranges using the Range Trie method of the present invention. The node illustrates an example of aligning address bounds and the incoming address A_{IN}. The length of the address range the node maps to is the result of subtracting the lower node bound address 634 from the upper node bound address 637, N_{L}=01110−10011=00101 which in this example requires 3-bits to be represented in binary “101” as the two most significant bits are zero. The number of bits required to represent the length of the node address range determines the number of suffix bits that will be used in the required computations of this node. Consequently, in this example the same number of the least significant address bits (three bits) will be useful in this node for the following computations. First the three least significant bits of the low node border 634 “--110” are subtracted form the three least significant bits of A_{IN}. The most significant bits that are omitted from the addresses are indicated by ‘-’. The three least significant bits of the result of the subtraction are compared against the three least significant bits of the result of the following computation: the three least significant bits of the low node bound 634 “--110” are subtracted from the three least significant bits of each address bound 635, 636 “--111” and “--010”. The result of the above comparisons determines the node branch to be taken. Notice that the bounds of the original node did not have a common prefix, but after the alignment there is a common prefix of 2 bits which are omitted from the computations of the node. Consequently, we only need to store and perform computations on only the three least significant bits of (1) the A_{IN}, the (2) low node bound 634, and (3) the address bounds 635, 636.

In general, the Range Trie nodes and branches according to the present invention can be mapped one-to-one to a (prior art) Range Tree data structure. As in a prior art Range Tree, a Range Trie node maps to an address range of the address space.

The union of the address ranges of (1) the nodes in a single tree level and (2) the leaf nodes of previous tree levels is the entire address space. The union of the children node address ranges is the address range of their parent node.

A node branch that points to the branch address range [Aₖ₋₁,Aₖ) is taken when the incoming address A_{IN} is in: Aₖ₋₁≦A_{IN}<Aₖ. However, the data stored in a Range Trie node according to the invention are significantly less than in a Range Tree node, while the computations needed to determine based on the incoming address the child-branch to be followed are also different. Also, prefixes can be stored to the data structure of the invention the same way it is stored in a prior art Range Tree.

A Range Trie node consists of parts of address bounds which may be arranged to consist according to a specific embodiment (1) a single common address part of two or more address bounds, (2) the remaining parts of each address bound after omitting any subset of bits that is not required for the comparison (omissible address parts); this subset of bits may be bits that are common for node address range, and may also be address bound suffix that has a value “0”.

Thus in accordance with FIGS. 5 and 6A-6C, the invention provides a method for constructing a decision tree for use in address lookup of a requested address in an address space,
the address space being arranged as a set of basic address ranges,
each basic address range being defined by a lower and an upper bound address;
an address in the address space being represented by a predetermined number of bits;
the method comprising:
   arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits, the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step, said all other address parts not being either the at least one common address part or the at least one omissible address part.

An incoming address A_{IN} that comprises an address in a predetermined address space is read. Next, the incoming address A_{IN} is defined by a number of bits that corresponds to the range of the address space.

Within the address space a number of address bounds which define basic address ranges R1, . . . , R7 exist. Each basic address range R1, . . . , R7 is in itself a sub-address space comprising a number of individual addresses.

Based on the number of address bounds, a decision tree is constructed which is used to determine in which basic address range the incoming address A_{IN} is located.

To determine the location of the incoming address within the address space, the method is arranged to carry out in a number of iterations, one or more comparisons of a value of subset of bits or the entire requested incoming address with one or more values of a subset of bits or the entire address bounds. The size of the subset of bits may vary between iterations. The decision tree is branched in such a way that after completing the iterations, the basic address range to which the incoming address belongs is determined. Below, the construction of the decision tree will be described in more detail.

In an embodiment, the invention provides the method as described above, which further comprises:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;

based on the at least one comparison branching to a node of the next level of the decision tree, until the basic address range has been determined when reaching one of the leaf nodes.

Next it is described one specific embodiment to reduce the number of address bound bits which need to be stored, read and processed in a node according to the method. In a node of the decision tree, bits that are in common for a number of address bounds may be combined in a common address parts as a subset of bits to be compared. Advantageously, these bits need to be stored only once in the node and only a single comparison for these bits is then required for more than one address bounds. In addition, bits that are in common for all addresses in the address range a node maps to, can be omitted from the comparisons. Also address bound suffix bits with value zero can be omitted from the comparisons. Finally, address bounds and requested incoming address may be properly aligned to minimize the information needed to be stored in the node.

The method applies a decision tree which according to the embodiment has the following properties:
A node maps to an address range of the address space. The union of the address ranges of (1) the nodes in a single tree level and (2) the leaf nodes of previous tree levels is the entire address space. The union of children node address range is the address range of their parent node;
The maximum number of address bits per comparison (or node branch in the decision tree) required to be processed at a node is log₂ D, where D is the length of the address range the node maps to;
Address suffixes can be omitted from processing, when their value is zero. In some cases one may force an address bound to have a suffix of value zero in order to reduce the data needed to be stored, then a new address bound is created although it was not included in the original set of address bounds which define the original set of address ranges to be stored in the decision tree.
Common address parts are shared among address bounds (node addresses); and
Addresses can be aligned properly to maximize their shared common prefix.

Corresponding to these properties, the method according to this embodiment provides some data processing rules. These rules intend to increase the number of branches per node given a specific memory bandwidth in order to reduce the depth of the decision tree.

Now consider the node 501 of FIG. 5. As the external characteristics of a Range Trie node is matching one to one with the external characteristics of a Range Tree node, FIG. 5 can be used to exemplify a Range Trie node.

A first rule (Rule 1) is to omit a common prefix of the node bounds 502, 503. When there is a common prefix CP of length L (L<W, W being the address width) of the node bounds at address Nₐ 502 and address N_{b} 503 then the L most significant bits of the addresses (incoming address and address bounds) can be omitted from the comparisons at the node.

A second rule (Rule 2) is to share the common prefix (most significant bits) A^{CP} of the address bounds Aᵢ 504 within the address range the node maps to. The common prefix A^{CP} of a plurality of address bounds Aᵢ of length L (L<W) can be shared among the multiple comparisons, stored only once and processed separately. Then if the A_{IN} prefix of length L is less than A^{CP}, then A_{IN}∈ R₁ (i.e., A_{IN} belongs to R1). If the A_{IN} prefix of length L is greater than A^{CP}, then A_{IN}∈ Rₖ₊₁. If the A_{IN} prefix of length L is equal to A^{CP}, then the comparisons of the (W−L)-bits suffix (least significant bits) of A_{IN} with the (W−L)-bits suffix of the address bounds Aᵢ 504 determine where A_{IN} belongs to.

A third rule (Rule 3) is to omit an address bound suffix of value ‘0’. Let an address bound Aᵢ 504 have a suffix of length L, where L<W, that is zero. Then, this suffix of Aᵢ 504 does not need to be compared against the L least significant bits of A_{IN}. Then the comparisons of the (W−L)-bits prefix (most significant bits) of A_{IN} with the (W−L)-bits prefix of the address bound Aᵢ 504 determine where A_{IN} belongs to.

A fourth rule (Rule 4) is to share a common suffix (least significant bits) A^{CS} of the address bounds Aᵢ 504 within the address range the node maps to. The common suffix A^{CS} of a plurality of addresses Aᵢ can be shared among the multiple comparisons and processed separately.

Let Rₚ=[A_{p 1}, Aₚ), (p ∈ natural numbers, 1≦p≦k+1) be the address range that the (W−L)-bit prefix comparisons of Aᵢ and A_{IN} indicate. Then, A_{IN}∈ Rₚ₋₁=[Aₚ₋₂, Aₚ₋₁) when all three conditions below are true:

(1) A_{IN} suffix of length L is less than A^{CS};

(2) A_{IN} prefix of length W−L is equal to the prefix of A₋₁;

(3) Rₚ≠R1

If one or more of the above three conditions is not met, then A_{IN}∈ Rₚ.

A fifth rule (Rule 5) is to use address alignment. The lookup of address A_{IN} in the node N that maps [Nₐ, N_{b}) with address bounds Aᵢ 504 is equivalent to the lookup of the address A′_{IN}=(A_{IN}−Nₐ) in a node N′ that maps to the address range [0, N_{b}−Nₐ) with address bounds A′ᵢ=(Aᵢ−Nₐ). Then, when A′_{IN} belongs to the address range of node N′, Rᵢ₌[A′ᵢ₋₁, A′ᵢ), A_{IN} belongs to the address range of the original node N, Rᵢ₌[Aᵢ₋₁, Aᵢ).

The fifth rule maximizes the benefits of the first rule and in essence is the means to achieve an essential property of the method of the invention: the maximum number of address bits a node needs to process is equal to the number of bits needed to represent the length of the node region, that is log₂(N_{b}−Nₐ).

A question arises regarding applying more than one of the above rules in parallel. Rules one to four can be applied independently as they do not affect each other. For instance, it is possible to omit using common node prefix (Rule 1), omit using any zero suffix (Rule 3), and then apply sharing address common prefix (Rule 2) and suffix (Rule 4) of the remaining address bits.

The fifth rule however is more difficult to apply in combination with one or more of the rules one to four. The fifth rule aims at maximizing common node prefix, consequently, it can be combined with the first rule, but needs to be applied before the second rule since the address prefixes change after the subtraction. Regarding zero and common address suffixes, the fifth rule can be applied independently. It is preferable to omit and share zero and common address suffixes (of length L) respectively using the original address values, and subsequently, to subtract in the remaining W−L address bits. This is feasible since instead of subtracting Nₐ 502, the W−L most significant bits of Nₐ 502 can be subtracted assuming the remainder being zero. In doing so, the benefits of sharing suffixes is preserved even when address alignment is applied and in addition the required address bits involved in the subtraction are reduced to only the ones that are needed for the prefix comparison.

It should be noted that the above Rules consider reducing the required parts of address bounds stored in a node and their respective comparisons. The same Rules can be applied to parts of address parts and their respective comparisons.

Finally, Rule 2 and Rule 4 can be extended to share any common address part of two or more node addresses.

### System

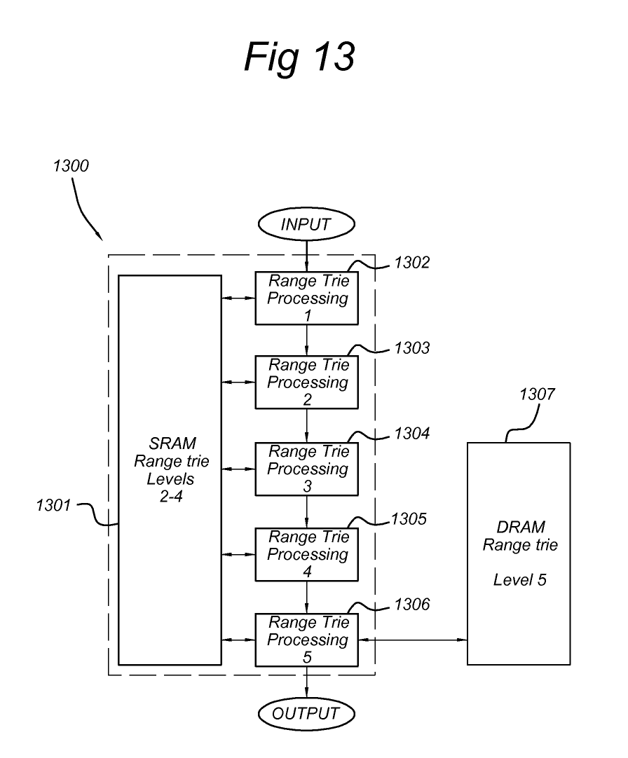

FIG. 13 schematically shows the block diagram of a system 1300 arranged for carrying out a method according to the present invention. The system comprises memory 1301 (for example, on-chip memory SRAM), Range Trie Processing units 1302-1306 each one carrying the processing of a single tree level, and optionally, if the memory is not sufficient to store all the Range Trie nodes, external memory 1307 (for example DRAM) to store the nodes of the last Range Trie levels (in the example shown the nodes of the fifth level are stored externally).

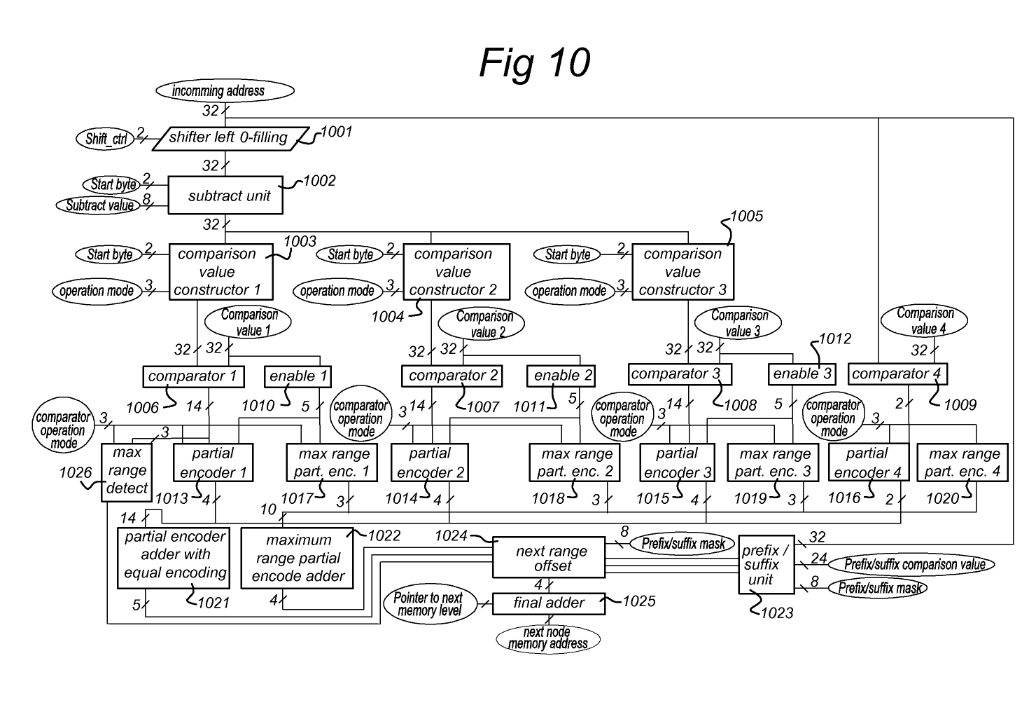

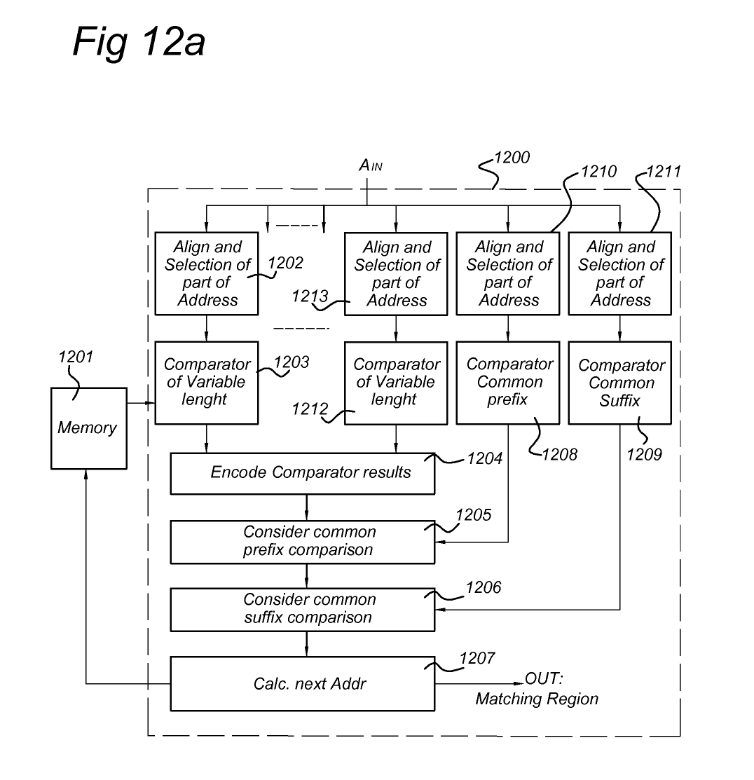

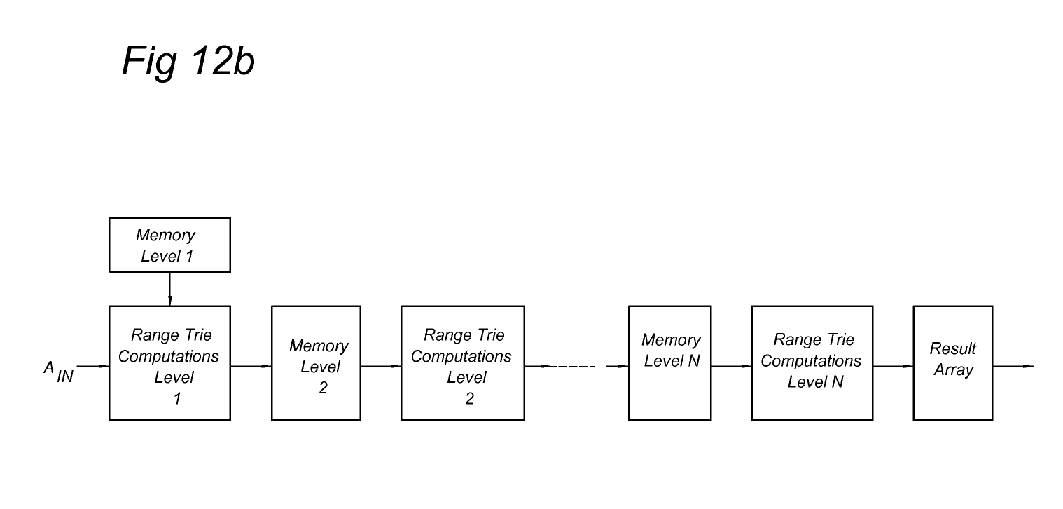

The internals of each of the Range Trie Processing units 1302, -1306 are described in detail below and illustrated in FIGS. 12A, 12B and further in an example hardware implementation as shown in FIG. 10.

The incoming address A_{IN}, depending on the application of the system, may be one or many packet fields extracted from the packet header of an incoming packet from the network through a network I/O device. Incoming address A_{IN} is entering the first level of Range Trie processing 1302, which may not need to read memory, as the first Range Trie level comprises a single root node and can be stored in registers in 1302. The Range Trie processing levels 2 1303, 3 1304, 4 1305, and 5 1306 perform the same computations as 1302 after reading from the memory (SRAM 1301 or DRAM 1307) the data of a Range Trie node determined by the previous Range Trie level processing unit. The Range Trie node stores address bounds in a compressed form according to the rules described hereinabove or in addition to these rules by using another compression technique. After the last Range Trie processing unit (level 5) the Result Array 804, which stores the actions of each basic address range or matching prefix, needs to be read from a memory unit. The matching basic address range for a given incoming address and/or the action associative with the basic address range is the output of the system.

The system 1300 is shown as a sequence of Range Trie processing units or processors that read and write in memory units 1301, 1307, however, it may comprise several sequences of processing units functioning in parallel or controlled by one main processor, that may be located remotely from one another, as is known to persons skilled in the art.

Examples of computer arrangements for carrying out the method of the invention are a (backbone) network router, a packet switching system, multi-service Internet Router, multi-field packet classification systems, a gateway, a server providing network services (supporting multi-cast, tunnels, virtual private networks, Quality of Service support), network security systems.

The Range Trie processing units 1302-1306 comprises functionality either in hardware or software components to carry out their respective functions as described in more detail below. Skilled persons will appreciate that the functionality of the present invention may be accomplished by a combination of hardware and software components. As known by persons skilled in the art, hardware digital components may be present within the Range Trie processing units 1302, 1303, 1304, 1305, 1306 or may be present as separate circuits which are interfaced with the Range Trie processing units 1302, 1303, 1304, 1305, 1306. Further it will be appreciated by persons skilled in the art that software components may be present in a memory region of 1302, 1303, 1304, 1305, 1306 or the memory units 1301, 1307.

The computer system 1300 shown in FIG. 13 is arranged for performing computations in accordance with the method of the present invention. The computer system 1300 is capable of performing computations according to configurations (or program code) residing on a computer-readable medium which after being loaded in the computer system allows the computer system to carry out the method of the present invention. The invention may take the form of a computer program containing one or more sequences of machine-readable instructions describing a method as disclosed above, or a data storage medium (e.g. semiconductor memory) having such a computer program stored therein.

Thus, the invention provides a computer system for constructing a decision tree for use in address lookup of a requested address in an address space,
the address space being arranged as a set of basic address ranges,
each basic address range being defined by a lower and an upper bound address;
an address in the address space being represented by a predetermined number of bits the computer system comprising a memory and a processor, the processor being coupled to the memory, wherein the processor is arranged for carrying out a method for constructing the decision tree for use in address lookup of the requested address in the address space, comprising:
   arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits, the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step,
said all other address parts not being either the at least one common address part or the at least one omissible address part.

The Range Trie processing unit 1302-1306 (or processor) is further arranged to carry the method of the invention comprising:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes.

Additionally, the invention provides a computer program on a computer-readable medium to be loaded by a computer system as described above, for constructing a decision tree for use in address lookup of a requested address in an address space, the address space being arranged as a set of basic address ranges,
each basic address range being defined by a lower and an upper bound address;
an address in the address space being represented by a predetermined number of bits;
the computer system comprising a memory and a processor, the processor being coupled to the memory, wherein the computer program product after being loaded allows the processor to carry out:
   arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches,
each node branch mapping to a respective non-overlapping branch address range in the node address range,
the branch address ranges being defined by node addresses in the node address range;
   decomposing each node address in a plurality of address parts, each address part being represented by a respective subset of the predetermined number of bits,
the decomposition comprising at least one of:
a) determining at least one address part which is common for multiple node addresses as an at least one common address part, and
b) determining at least one further address part which is omissible as an at least one omissible address part, the at least one omissible address part being either a node address suffix of value ‘zero’ or an address part which is common for all addresses in the node address range;
   storing the plurality of address parts in the at least one node according to a selection rule,
the selection rule comprising at least one action from a group of actions, the actions comprising:
   storing the at least one common address part only once in the node;
   omitting the at least one omissible address part, and
   storing in the node all other address parts as determined in the decomposition step, said all other address parts not being either the at least one common address part or the at least one omissible address part.

Moreover, the invention provides a computer-readable medium being provided with a computer program as described above.

According to the method, the Range Trie processing unit 1302, 1303, 1304, 1305, 1306 receives an incoming addresses A_{IN} to perform address lookup according to the present method. The incoming address is extracted from a packet header of incoming packets from the network through a network I/O device. The incoming address A_{IN} may comprise the destination address of the packet, but also or alternatively the source address, source port, destination port, and/or protocol. The incoming address A_{IN} is an address within an address space that covers an address range of a predetermined number of bits.

The Range Trie processing units 1302, 1303, 1304, 1305, 1306 then in a number of iterations, select in each iteration a subset of bits from the predetermined number of bits of the incoming address. Next in each iteration, the Range Trie processing units 1302, 1303, 1304, 1305, 1306 compare a value of the subset of the predetermined number of bits with a value of a subset of bits from the address space.

Further, the Range Trie processing unit 1302, 1303, 1304, 1305, 1306 may be arranged to carry out an algorithm that is defined in accordance to one or more of the first, second, third, fourth and fifth rule, as described above.

FIG. 12A schematically shows a functional block diagram of a further computer system 1200 arranged for carrying out a method according to the present invention.

Under circumstances, it may be more efficient to implement the method of the invention in hardware rather than software where multiple bit-manipulation instructions are required to shift addresses, select parts of them to be compared and select the matching region. On the other hand, software implementations can also benefit from the method of the invention since the method reduces the number of memory accesses and reducing the number of memory accesses would obviously improve performance.

The further computer system 1200 comprises memory 1201, address align and selection of a part of address 1202, 1213, comparators 1203, 1212, common prefix address align and selection 1210, common prefix comparator 1208, common suffix address align and selection 1211, common suffix comparator 1209, encoder unit which outputs a result based on the individual comparisons of parts of addresses 1204, a module that modifies if necessary the result of the encoder according to the common prefix comparison result 1205, a module 1206 that modifies if necessary the result of module 1205 according to the common suffix comparison result, a module 1207 that calculates the next address to read from memory 1201.

Generally speaking, the incoming address A_{IN} is aligned properly in 1202, 1213 and part of it feeds the parallel comparators 1203, 1212. The comparators 1203, 1212 can be configured to perform comparisons of variable lengths which may vary in different implementations e.g., 8, 16, or 32 bits. The available memory bandwidth and the length of comparisons performed determines the total number of available comparisons; e.g., for 256 bits memory bandwidth and 32-bit comparators, which can be configured as multiple 8-bit and 16-bit comparisons, we can have seven 32-bit comparators 1203, 1212 and the remaining 32-bits are for the common prefix 1208 and suffix 1209. The second input of each comparator is read from the memory 1201 and comprises one or more decision tree bounds of a single iteration (tree node) generated by a heuristic given a set of address ranges. Examples of heuristics will be discussed in more detail below. Two other comparators 1208, 1209 compare common address prefix and suffix in parallel. Subsequently, the individual comparators results are encoded in 1204. The common prefix output is taken into account in 1205 according to rule two. Then the common suffix comparison is considered in 1206 according to the rule four. The above can be implemented in a pipeline fashion as illustrated in FIG. 12B such that each iteration is performed in a separate stage having a separate memory block. In doing so, the overall throughput can be improved at the cost of extra hardware. Alternatively, the pipeline stages can be doubled having the comparisons and the memory accesses in different stages to improve cycle time.

Below a more detailed description and example of a Range Trie data structure, node description and hardware implementation in accordance with an aspect of the invention are shown.

The invention provides a rapid search to identify the basic address range in the address space that the incoming address belongs to.

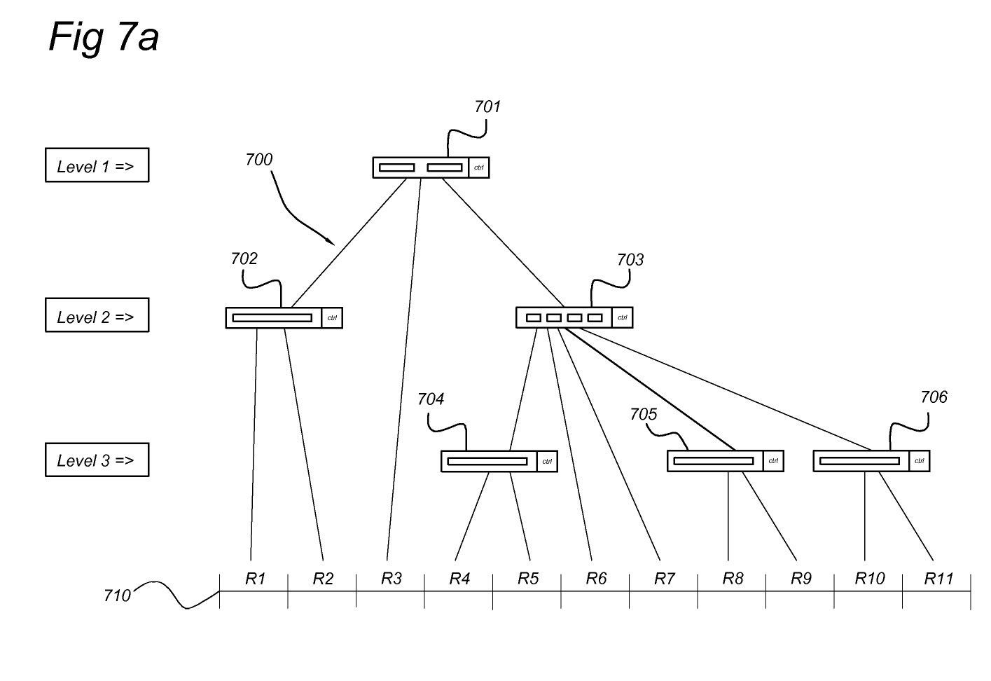

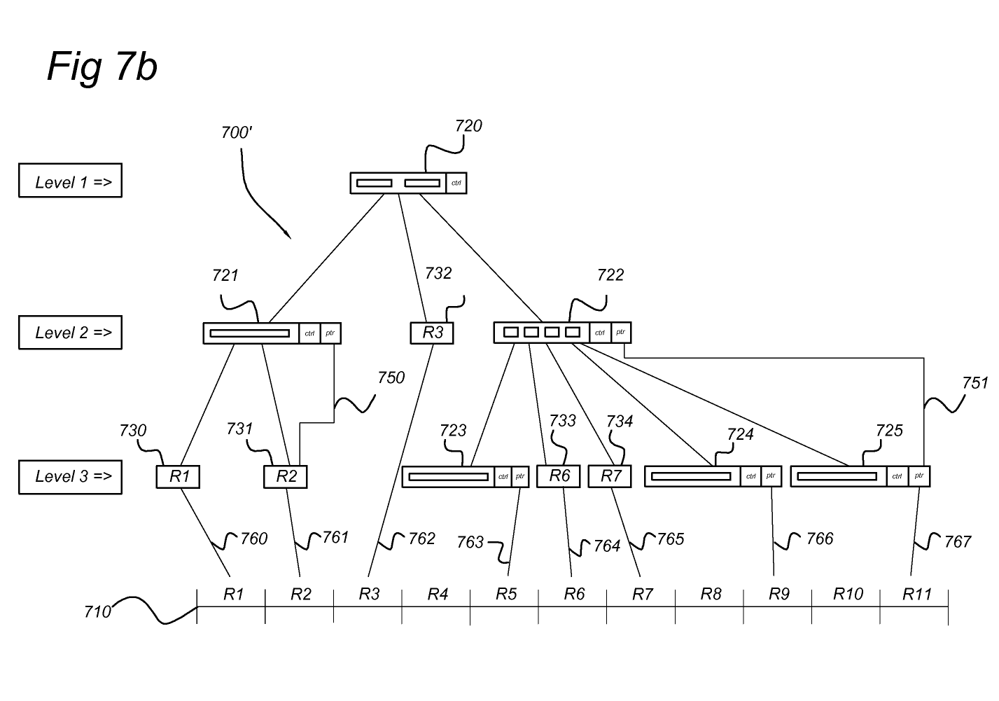

FIG. 7A shows a diagram of a Range Trie, according to the invention, and FIG. 7B shows a diagram of the Range Trie after an annotation operation with extra leaf nodes and pointers.

First, a Range Trie 700 as shown in FIG. 7A is annotated (a) with extra leaf nodes 730-734 holding pointers 760, 761, 762, 764, 765 to the result array 710, (b) pointers 750, 751 to the rightmost child of each non-root non-leaf node and (c) pointers 763, 766, 767 from leaf nodes to the result array 710.

The annotation operation provides an annotated Range Trie 700′ as shown in FIG. 7B.

By way of example, the original Range Trie 700 has 3 levels of nodes.

The annotated Range Trie 700′ has also 3 levels of nodes, because extra leaf nodes are not added below level 3 nodes. Each extra leaf node 730-734 is added to the annotated Range Trie 700′ in case a non-level-3 node 701-703 of the original Range Trie 700 points directly to address range Rᵢ in the result array 710.

The extra leaf node is placed in the next level of the Range Trie node that points to it and holds a pointer to address range Rᵢ in the result array. (I.e. root node 701 is a parent to nodes 702, 703 and also points directly to R3 in result array 710. This leads to the creation of extra leaf node 732 that is placed in level 2 of the annotated Range Trie 700′ as a child node of the root node 720 between children nodes 721, 722.

The extra leaf node 732 holds a result array pointer 762 to address range R3 in the result array 710. In a similar fashion the Range Trie 700′ is annotated with extra leaf nodes 730, 731, 733, 734.)

The annotation of Range Trie 700′ continues by linking non-root non-leaf nodes 721, 722 with their rightmost child nodes 731, 725 by using pointers 750, 751 to the rightmost child.

The annotation of Range Trie 700′ is completed by linking leaf nodes 723-725 with the rightmost result in result array 710 that each of nodes 704-706 of Range Trie 700 is pointing to by using the pointers 763, 766, 767 to the result array.

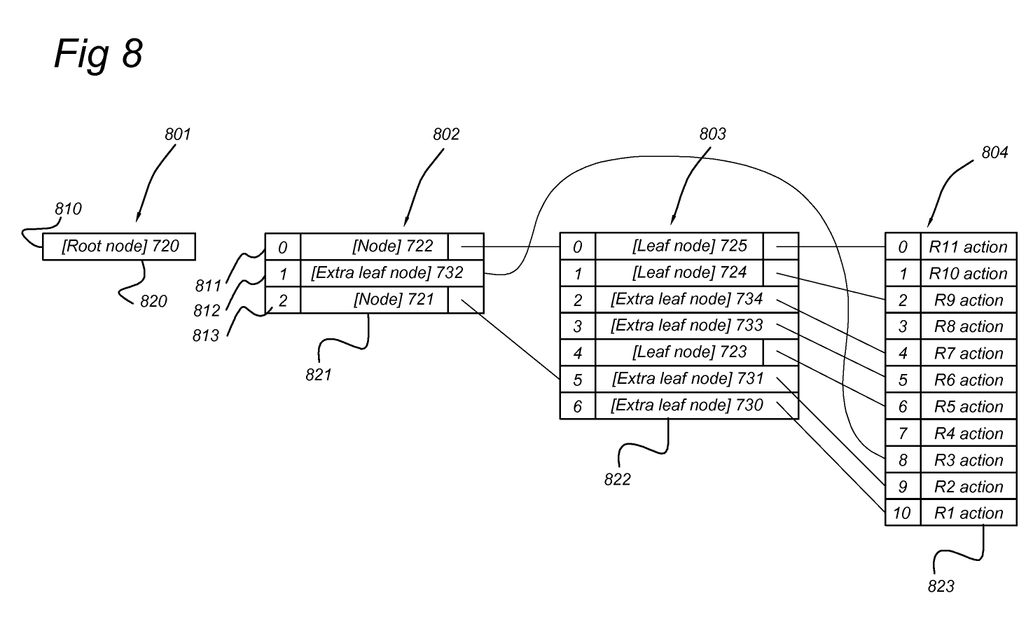

Next, according to the invention, each node of the 3-level annotated Range Trie 700′ is placed in an entry of the 4-level memory hierarchy illustrated in FIG. 8.

FIG. 8 is a diagram showing the arrangement of the annotated Range Trie nodes in the memory hierarchy, according to the invention.

FIG. 8 also shows the organization of the nodes into the memory hierarchy and the semantics of the pointers that annotate Range Trie 700′. The single entry 810 of memory level 1 801 is filled by root node 720 of the annotated Range Trie 700′. Memory level 2 802 and memory level 3 803 are filled by nodes of level 2 and level 3 of the annotated Range Trie 700′. Every consecutive memory entry of memory level i is filled by a node starting from the rightmost node of level i of the annotated Range Trie 700′ and moving towards the leftmost node. Memory level 2 802 is set up with nodes from level 2 of 700′; node 722 in entry 0 811, extra leaf node 723 in entry 1 812 and node 721 in entry 2 813. In the same manner, memory level 3 803 is filled up. The result array 710 resides in the fourth memory level 804 where it is placed starting from the rightmost range of the result array 710 and moving towards the leftmost range. After the search to identify the range that the incoming address belongs to is complete, the entry of the respective range in the result array 804 is obtained to determine the action 823 to be taken. I.e., in the case of packet classification and IP lookup the result sought is often the next hop address, but may be the disposition of the packet or some modification of the packet header.

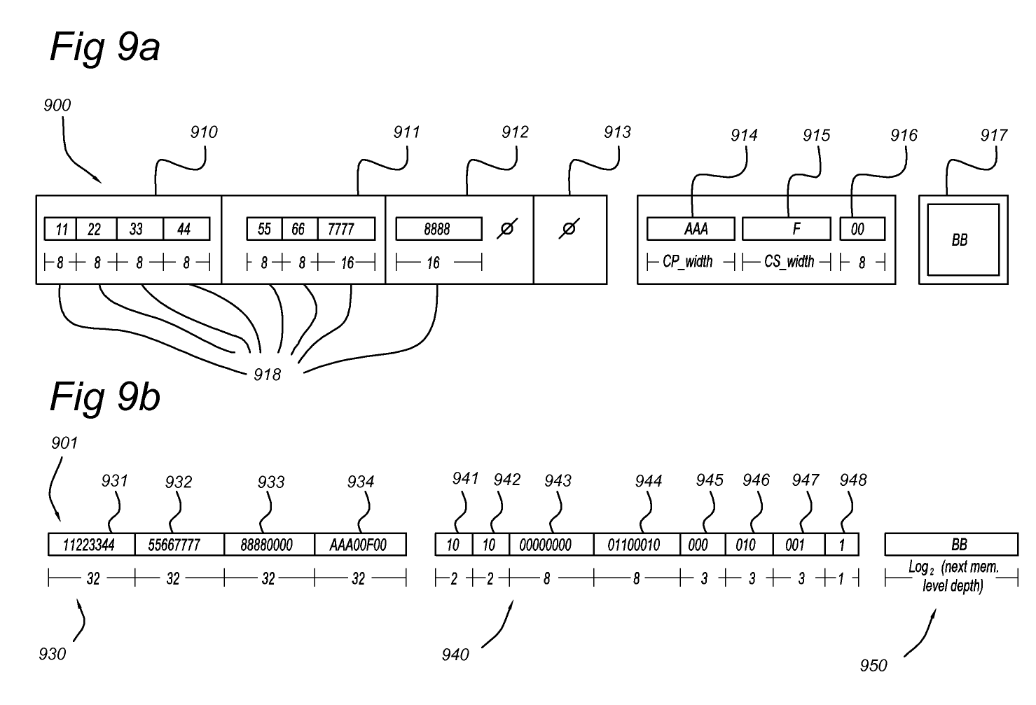

Before placing the nodes of the annotated Range Trie 700′ in the memory levels 1-3 801-803, they must first be encoded into the node data structure 901 represented in FIG. 9.

FIG. 9 depicts an example representation of a Range Trie node 900 into a node data structure 901. The information in a Range Trie node 900 holds all the necessary details for the computations to be performed when traversing through a Range Trie node 900 during the search.

By means of example, the incoming address width and the width of the available comparators are assumed to be 32 bits. The available memory bandwidth is assumed to be 128. Thus, there are 4 (four) available comparators. Comparison values (address parts) for comparators 1-3 931-933 in the node data structure 901 are filled with the single comparison values 918 for comparators 1-3 910-912 of the node 900. The comparison values for comparator 3 912 are less than 32 bits wide in total, thus the remaining bits in comparison value for comparator 3 933 are set to 0's. The 32 least significant bits 934 of comparison values 930 hold either the prefix/suffix comparison value 914-915, or the comparison value for comparator 4 913 (if valid).

The mode of operation of comparators 1-4 910-913 (i.e. [8 8 8 8], [8, 8, 16], [16, 0], disabled), is encoded into values placed in comparators 1-4 operation mode 945-948. Shift control 941 (for byte alignment), comparison start byte 942, subtract value 943 and prefix/suffix mask 944 are set based on the values of common prefix 914, common suffix 915 and subtract value 916.

To complete the node data structure 901, the pointer 950 to the next memory level is filled with the pointer 917 of the node 900. The root node 720, that is represented with data structure 901, has not a pointer to the next memory level 950, as the root node is always pointing to entry 0 811 of memory level 2 802.

Another special case is representing extra leaf nodes 730-734 into the node data structure 901. Extra leaf nodes hold only a pointer 760, 761, 762, 764, 765 to the result array 710. The node data structure 901 for a leaf node is filled completely with 0's, except it's most significant bits that hold the pointer to the result array and it's compare mode for comparator 1 945 holding a special encoding to state that this node is an extra leaf node.

After setting up the memory hierarchy with the data structures, the address lookup according to the method of the present invention may start operation. The computation may now commence starting with retrieving the root node 720 data structure from the single memory entry 810 of memory level 1 801.

Required Computations

After a Range Trie node data structure has been retrieved from memory, there are several required computations in order to proceed along the search path to subsequent Range Trie nodes, until the search is complete.

The first part of the required computations is shown in Table 1 where the values to be compared in the comparators are computed based on the incoming address. As an example, the node represented in 901 in FIG. 9 is used. First, according to the invention, the input address is shifted shift_ctrl*2 941 bits left and it is filled with 0's on the right (as shown in Line 1 of Table 1). In this embodiment of the invention, shifting is assumed to be performed towards left by 0, 2, 4 or 6 bits in order to byte align the incoming address. Then the subtract value 943 is added only to the start byte 942 of the shifted incoming address (as shown in Line 2 of Table 1), as dictated by this embodiment of the invention. The bytes are counted starting from the most significant bit. Afterwards, the values to be compared in the 4 comparators are constructed, based on the comparator operation modes 945-948 and start byte 942 (as shown in Line 3 of Table 1). The comparator operation modes 945-948 determine the width of the useful comparisons to be performed in a comparator. In the example, the 32-bit comparator 1 will compare 4 8-bit values. This means that the value to be constructed for the comparison consists of 4 times the 8-bits starting from start byte.

The second part of the required computations is shown in Table 2 where the comparisons are performed and the result is encoded into a single value. The computations will be based on the data of the range node data structure 901 that was retrieved from the memory hierarchy.

TABLE 1
Example for incoming address: AAA6998F
Current node data structure: 901
1. Shift left by shift_ctrl * 2 bits (0 filling)

| | |
|---|---|
| AAA6998F << 4 = | AA6998F0 |

2. Add subtract value to start byte only

| | |
|---|---|
| AA6998F0 + 00000000 = | AA6998F0 |

3. Construct value for comparator i,
based on comparator operation mode and start byte

| | | |
|---|---|---|
| i = 1 | cmp_mode = [8, 8, 8, 8] | 69696969 |
| i = 2 | cmp_mode = [8, 8, 16] | 69696998 |
| i = 3 | cmp_mode = [16, 8, 8] | 69986969 |
| i = 4 | cmp_mode = disabled | XXXXXXXX |

First, the comparison is performed between the values constructed in Line 3 of Table 1 and the comparison values 931-933 for comparators 1-3 (as shown in Line 1 of Table 2). Each comparator performs comparisons as if operating in modes [32], [16,16] and [8,8,8,8] simultaneously. The output of each comparison is one result bit (1: if less, 0: if greater equal) and one equal bit (1: if equal, 0: if not equal). The comparator outputs (res8, res16, res32, equal8, equal16, equal32) in Line 1 of Table 2 are in binary and each bit corresponds to one of the comparisons performed.

TABLE 2
Example for incoming address: AAA6998F
Current node data structure: 901
1. Compare constructed value for comparator i with comparison value i

| | | | | |
|---|---|---|---|---|
| i = 1 | 69696969 | 11223344 | | |
| | | res32 = 0 | res16 = 00 | res8 = 0000 |
| | | equal32 = 0 | equal16 = 00 | equal8 = 0000 |
| i = 2 | 69696998 | 55667777 | | |
| | | res32 = 0 | res16 = 01 | res8 = 0010 |
| | | equal32 = 0 | equal16 = 00 | equal8 = 0000 |
| i = 3 | 69986969 | 88880000 | | |
| | | res32 = 1 | res16 = 10 | res8 = 1000 |
| | | equal32 = 0 | equal16 = 00 | equal8 = 0000 |

2. Determine array of valid comparison results of comparator i

| | | | | |
|---|---|---|---|---|
| i = 1 | [8, 8, 8, 8] | 11223344 => all | res = 0000 | equal = 0000 |
| | | comparisons valid | | |
| i = 2 | [8, 8, 16] | 55667777 => all | res = 001 | equal = 000 |
| | | comparisons valid | | |
| i = 3 | [16, 8, 8] | 88880000 => 2 | res = 1 | equal = 0 |
| | | last 8-bit | | |
| | | comparisons | | |
| | | invalid | | |

3. Calculate result and equal encoding for each comparator i

| | | |
|---|---|---|
| i = 1 | res = 000 | equal = 0 |
| i = 2 | res = 001 | equal = 0 |
| i = 3 | res = 001 | equal = 0 |

4. Calculate result and equal encoding for the complete set of
comparisons

| | |
|---|---|
| res = 0010 | equal = 0 |

Afterwards, only the valid results are collected (as shown in Line 2 of Table 2). Based on the comparator operating mode and if a comparison is valid (if all bits of the value to be compared are non-zero), an array of bits is obtained created from the comparison result bits. I.e. comparator 2 operates in mode [8,8,16] and all comparisons are valid, so the valid comparison results for comparator 2 are res8(3), res8(2), res16(0) and equal8(3), equal8(2), equal16(0).

Then the encoding of each comparator result is performed (as shown in Line 3 of Table 2) by counting the number of valid comparisons that reported less (which is encoded to 1). To complete the calculation, the results produced in Line 3 of Table 2 are added as binary numbers to form the comparison's result (as shown in Line 4 of Table 2).

During the computations of Table 2, the comparators provide also a result regarding the equality of the comparisons performed. This result is treated as mentioned but instead of counting 1's and adding values to each other, a logic OR is performed between the valid equality results.

The last part of the required computation is shown in Table 3 and leads to the computation of the next memory entry to be processed or to a final result in the result array. First, the maximum possible encoding of the comparisons' results (max_range) is computed (as shown in Line 1 of Table 3). It assumes that the output of the comparators 1-3 is all-1's and performs similar steps to those in Lines 2-4 of Table 2.

Afterwards, it is determined if the encoded result of Line 4 of Table 2 is equal to the max_range value (as shown in Line 2 of Table 3). The result of this computation is stored in is_max_range bit (1: if equal, 0: if not equal). This is performed by inspecting the most significant bits of the results of comparator 1, while taking into account its comparison operation mode.

Before computing the next memory entry to be processed, the prefix/suffix of the incoming address should be compared to the prefix/suffix comparison value 934 in the prefix/suffix comparator (as shown in Line 3 of Table 3). The widths of prefix/suffix are obtained from the prefix/suffix mask 944. The prefix/suffix comparison provides the results prefix_less (1: if incoming prefix less than common prefix, 0: otherwise), prefix_equal (1: if incoming prefix equal to common prefix, 0: otherwise), suffix_less (1: if incoming suffix less than common suffix, 0: otherwise), suffix_equal (1: if incoming suffix equal to common suffix, 0: otherwise).

The last step of the computation is to calculate the address of the next node to be retrieved from the memory. This address is calculated as the sum of the pointer 950 to the next memory level (if it exists) and the next range offset (as shown in Line 4 of Table 2).

TABLE 3
Example for incoming address: AAA6998F
Current node data structure: 901
1. Calculate maximum possible result encoding

| | | | |
|---|---|---|---|
| i = 1 | [8, 8, 8, 8] | 11223344 => all | max = 100 |
| | | comparisons valid | |
| i = 2 | [8, 8, 16] | 55667777 => all | max = 011 |
| | | comparisons valid | |
| i = 3 | [16, 8, 8] | 88880000 => 2 last 8-bit | max = 001 |
| | | comparisons invalid | |
| i = 4 | disabled | | max = 0 |
| | | | max_range = 1000 |

2. Calculate if result encoding has max_range value

is_max_range = 0

3. Compare incoming address prefix/suffix with common prefix/suffix

| | |
|---|---|
| incoming prefix: AAA | prefix_less = 0 |
| common prefix: AAA | prefix_equal = 1 |
| incoming suffix: F | suffix_less = 0 |
| common suffix: F | suffix_equal = 1 |

4. Calculate next range offset and next range to proceed

next range offset = 0010
pointer to next memory
level = BB
next range memory
location = BD

The next range offset is determined as a function of: (a) the computed encoded result and equal (in Line 4 of Table 2), (b) the computed max_range, is_max_range, prefix_less, prefix_equal and suffix_less (in Table 3) and (c) the prefix/suffix mask 944. In particular, if the incoming prefix is less than the common prefix, then the next range offset is the maximum possible one (max_range). If the incoming prefix is greater than the common prefix, then the next range offset is 0. If the incoming prefix is equal to the common prefix, then the next range offset is the encoded result or the encoded result incremented by 1 (when the incoming suffix is less than the common suffix, the encoded result is not equal to max_range and the encoded equal is 1).

At this point, the address of the next node to be retrieved from the memory is known. The respective memory entry is retrieved from the next memory level and the computations repeat for the new node data and the same incoming address. This search is continued until reaching a result.

In case, the node under computation is an extra leaf node, then the computation reduces to retrieving the pointer to the result array.

Although the computations in Lines 1-3 of Table 3 were presented sequentially, they may be performed in parallel to each other and in parallel to the computations of Tables 1, 2.

Architecture for the Required Computations

FIG. 10 is a block diagram depicting the functional units of the invention and their interconnection, according to the invention.

The computations described in Tables 1-3 may be carried out in functional units as depicted in FIG. 10. A memory bandwidth 128 bits wide, a maximum comparator width 32 bits and an incoming address 32 bits wide are assumed for this embodiment of the invention. The skilled in the art will appreciate that the invention may be embodied by using other values of bandwidth and comparator width.

The inputs to the computation needed for this embodiment of the invention are: the incoming address (32-bits wide), the shift control (2-bits wide), the start byte (2-bits wide), the subtract value (8-bits wide), the comparator's 1-3 operation modes (3-bits wide each, 9-bits wide in total), the comparison values 1-4 (32-bits wide each, 128-bits wide in total), the prefix/suffix comparison value (24-bits wide),the prefix/suffix mask (10-bits wide) and the pointer to the next memory level (as wide as the address of the next memory level). These inputs are connected to the functional units of FIG. 10. Along with the physical coupling between the units, the computation may be carried out.

Specifically, shifter left with 0-filling 1001 is connected to the incoming address input and the input shift_control value. It is connected with the subtract unit 1002 through its shifted value output (32-bits wide).

The subtract unit 1002 is connected to the input start byte value, the input subtract value and the shifted value output of 1001. Its output (subtracted value: 32-bits wide) is connected with the comparison value constructor 1-3 units 1003-1005.

The comparison value constructor 1-3 units 1003-1005 are connected with the comparator 1-3 units 1006-1008 through their output (constructed comparison value: 32-bits wide). To calculate the output, they are connected with the input start byte value, the comparator 1-3 operation mode and the subtracted value output of 1002.

The comparator 1-3 units 1006-1008 are connected with the partial encoder 1-3 units 1013-1015 through their output (comparison result: 14-bits wide). To calculate the output, they are connected with the input comparison value 1-3 and the constructed comparison value 1-3 output of 1003-1005.

An extra coupling is present for comparator 1 unit 1006 with the max range detect unit 1026 through 3-bits of the comparison result output of 1006.

The comparator 4 unit 1009 is connected with the partial encoder 4 unit 1016 through its output (comparison result: 2-bits wide). To calculate the output, it is connected with the input comparison value 4 and the input incoming address.

The enable 1-3 units 1010-1012 are connected with the partial encoder 1-3 units 1013-1015 and the max range partial encoder 1-3 units 1017-1019 through their output (valid comparisons: 5-bits wide). To calculate the output they are connected with the input comparison value 1-3.

The partial encoder 1-3 units 1013-1015 are connected to the partial encoder adder with equal encoding unit 1021 through their output (each partial encoding: 4-bits wide, 12-bits wide in total). To calculate the output they are connected with the input comparator 1-3 operation mode, the comparator 1-3 unit 1006-1008 result output and the enable 1-3 unit 1010-1012 result output.

The partial encoder 4 unit 1016 is connected to the partial encoder adder with equal encoding unit 1021 through its output (partial encoding: 2-bits wide). To calculate the output it is connected with the input comparator 4 operation mode and the comparator 4 unit 1009 result output.

The max range partial encoder 1-3 units 1017-1019 are connected to the maximum range partial encode adder unit 1022 through their output (each max range partial encoding: 3-bits wide, 9-bits wide in total). To calculate the output they are connected with the input comparator 1-3 operation mode and the enable 1-3 unit 1010-1012 result output.

The max range partial encoder 4 unit 1020 is connected to the maximum range partial encode adder unit 1021 through its output (partial encoding: 1-bit wide). To calculate the output it is connected with the input comparator 4 operation mode and the comparator 4 unit 1009 result output.

The max range detect unit 1026 is connected to the next range offset unit 1024 through its output (max range detected: 1-bit wide). To calculate the output it is connected with the input comparator 1 operation mode and 3 bits of the comparator 1 unit 1006 result output.

The partial encoding value outputs of partial encoder 1-4 units 1013-1016 form the 14-bits wide input of partial encoder adder with equal encoding unit 1021. This unit is connected to the next range offset unit 1024 through its 5-bits wide output.

The max range partial encoding value outputs of max range partial encoder 1-4 units 1017-1020 form the 10-bits wide input of maximum range partial encoder adder unit 1022. This unit is connected to the next range offset unit 1024 through its 4-bits wide output.

The prefix/suffix unit 1023 is connected to the next range offset unit 1024 through its outputs (1-bit wide prefix-equal, 1-bit wide prefix-less, 1-bit wide suffix-less). To calculate the output it is connected with the input incoming address, the input prefix/suffix comparison value and the input prefix/suffix mask.

The next range offset unit 1024 is connected to the final adder unit 1025 through its output (next range: 5-bits wide). To calculate the output it is connected with the outputs of units 1021, 1022, 1023, 1026 and the input prefix/suffix mask.

The final adder unit 1025 produces the output of the calculation that is as wide as the address of the next memory level. To calculate the output it is connected with the output of the next range offset unit 1024 and the input pointer to the next memory level.

The functional units of FIG. 10 operate on the incoming address and the node data structure to determine the location of the next Range Trie node in the next memory level.

Shifter left with 0-filling 1001 is arranged to perform the computation in Line 1 of Table 1. It shifts the incoming address by 0, 2, 4 or 6 bits depending on the shift_ctrl value. Other embodiments of the invention may perform another number of bitshifts or perform shift in a different way.

Subtract unit 1002 is arranged to add subtract value to the start byte of the shifted incoming address and, therefore, it performs the computation in Line 2 of Table 1.

The comparison value constructor 1-3 units 1003-1005 is arranged to construct the value to be compared in comparator 1-3 units 1006-1008. The value is constructed as described in Line 3 of Table 1 based on the values of start byte and comparison operation modes 1-3.

The comparator units 1-3 1006-1007 is arranged to compare the constructed values against the values for comparison 1-3, as in Line 1 of Table 2. The output of the comparators is 14 bits wide, representing the comparison outcome (greater equal/less, equal) for all possible widths of comparisons.

The enable units 1010-1012 is arranged to determine if the rightmost comparisons inside a comparator are disabled, assuming that the comparison values are filled starting from the leftmost bit, in this embodiment of the invention. This situation is identified when the corresponding value for the comparison in the values for comparison is equal to 0. The result of the enable units is passed to partial encoder units 1013-1015 and maximum range partial encoder units 1017-1019, along with the comparator 1-3 operation mode. These units can determine which comparison results are enabled/valid and can compute (a) the encoded result/equal of every comparator (Line 2-3 of Table 2) by counting the valid comparison results that report less (encoded to 1) and by performing logic OR on the valid equality results and (b) the encoded maximum range of every comparator (Line 1 of Table 3) by counting the valid comparison results (encoded to 1) when all the comparison results are assumed to be 1.

In this embodiment of the invention, the comparison in comparator unit 4 1009 is performed directly between the incoming address and the value for comparison 4, without the need of a comparison value constructor and an enable unit. The comparison output is trivially encoded by partial encoder unit 1016 and max range partial encoder unit 1020, based on the comparator 4 mode of operation.

The partial encoder units 1-4 1013-1016 outputs are arranged to be added in the “partial encoder adder with equal encoding” unit 1021 to compute the encoded result of all the comparisons (as in Line 4 of Table 2). This unit also computes the encoded equal result by means of a logic OR.

In a similar way as 1021, the maximum range partial encoder adder 1022 is arranged to add the output of the maximum range partial encoder 1-4 units 1017-1020 in order to calculate the maximum range (as in Line 1 of Table 3).

The maximum range detect unit 1026 is arranged to check the most significant bits of the comparator unit 1 1006, and decides whether the encoded comparison result is equal to the maximum possible range.

The prefix/suffix unit 1023 is arranged to perform the computation of Line 3 of Table 3 and the output is connected to the next range offset unit 1024.

The next range offset unit 1024 is arranged to decide a value of the next range offset based on the outputs of 1021 (encoded result of comparisons and encoded equality result), 1026 (is_max_range), 1022 (maximum range), 1023 (prefix_less, prefix_equal, suffix_less) and the prefix/suffix mask.

The computation steps are completed by adding the next range offset to the pointer to the next memory in the adder unit 1025. At this point, it is possible to retrieve the next node from the memory and repeat the required computations for the same incoming address, until a result is reached.

Combinational Logic Design of the Units

Shifter left with 0-filling 1001 is implemented as an array of 2-bits wide 4-to-1 multiplexers controlled by shift_ctrl.

Subtract unit 1002 is implemented as an array of four 8-bits wide adders. The subtract value is only added in the respective adder of start byte; the other additions are omitted by adding 0's. The 8-bits adders are implemented as 2-level carry select adders and the 4-bits adders of each level are implemented as carry look-ahead adders.

Each comparison value constructor 1-3 unit 1003-1005 is implemented as an array of 4 8-bits wide 4-to-1 multiplexers controlled by a logic function of start byte and comparator operation mode.

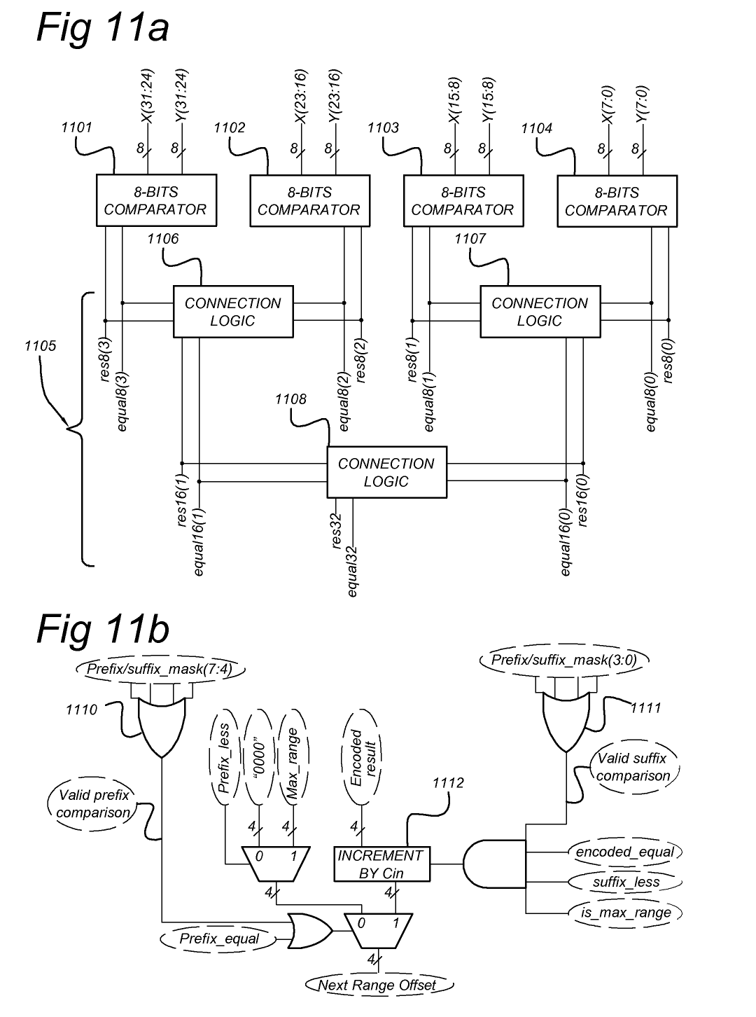

FIG. 11A shows the implementation of a 32-bits wide comparator unit 1006-1009 as shown in the example of FIG. 10.

The 32-bits wide comparator unit performs one comparison of 32-bits, two comparisons of 16-bits and four comparisons of 8-bits. It is implemented using 8-bits comparators 1101-1104 and their results are combined in an inverted tree fashion 1105. In the inverted tree 1105, connection logic 1106-1108 is used to form the result of larger comparisons. The possible results of the comparisons are: greater, equal/less and equal.

Partial encoder 1-3 units 1013-1015 use the bits of comparison operation modes 1-3 and the output of enable units 1-3 1010-1012 to determine the valid outputs of the comparator units 1-3 1006-1008. Then the valid results are added in an adder of four 1-bit inputs and a logic OR is performed on the equality results.

The partial encoder adder with equal encoding unit 1021 is implemented as a carry sum adder that adds 3 3-bits values and 1 1-bit value. At the final level of the carry sum adder there is a carry look-ahead adder to get the result encoding. In parallel to the addition, a logic OR of the equality results is performed.

If a common prefix/suffix comparison must be performed, then the common prefix bits and common suffix bits of the incoming address are retrieved in the prefix/suffix unit 1023 by using the prefix/suffix mask value. These bits are then compared to the respective prefix/suffix value bits in two 24-bits wide comparators. The 24-bits wide comparators are implemented in a similar way as the 32-bits comparators.

FIG. 11B depicts an implementation of the next range offset unit 1024.

First, the next range offset unit 1024 determines if there is a valid prefix and suffix comparison by performing a logic OR 1110, 1111 on the respective bits of the prefix/suffix mask. Then the next range offset is computed and it may be: (a) 0, (b) max_range, (c) encoded result or (d) encoded result+1. The conditions for each case are depicted in the logic design of the unit in FIG. 11B. An incrementor 1112 by 1 adds 1 only when the “carry in” is 1, otherwise it's output is identical to its input.

The final adder 1025 is implemented as a two level carry select adder. The first level is as wide as the next range encoding and is implemented by a carry look-ahead adder. The second level chooses between the rest bits incremented by 1 or not incremented by 1, depending on the carry out of the first level.

The remaining logic is familiar to those skilled in the area of digital system design.

The enable units 1010-1012 are implemented as a hierarchy of OR logic gates.

The maximum range partial encoder units 1017-1019 is almost the same with the partial encoder units 1013-1015 without the equality results and assuming that the comparator results are all 1's.

The fourth partial encoder unit 1016 and the fourth maximum range partial encoding unit 1020 are a subset of their counterparts for comparators 1-3 keeping in mind that comparator unit 4 1009 operates in two modes (enabled/disabled).

The embodiments described hereinabove illustrate examples of designs for rapid address lookup and prefix matching that employ the Range Trie according to the invention. The Range Trie method and system according to the invention provide an excellent balance between simplicity and speed. Some other implementations, in addition, can be easily developed by one of ordinary skill in the area of digital system design who follows the teachings as described above.

A Range Trie node can store a plurality of address bounds in a compressed form in addition to the rules described hereinabove which share common address bounds parts, omit address bound parts, and align addresses. In such case decompression of the node data read from a computer-readable medium is required prior to the computations described hereinabove.

Alternatively, Range Trie node can store a plurality of address bounds compressed in another way. Then decompression and retrieval of the original bounds is required and subsequent comparisons between the requested incoming address and the address bounds stored in the node will determine the branch to be taken.

In both these cases as well as in the specific embodiment described in detail hereinabove the main advantage of the Range Trie is increasing the number of address bounds explicitly or implicitly stored in node stored in a predetermined number of bits. In so doing, an increased number of branches per node is achieved and thus a shorter and more scalable decision tree is constructed.

Below we describe four heuristics that can be used to construct a Range Trie data structure according to the invention given a set of address bounds which define address ranges.

Given a set of k addresses Aᵢ that define k+1 basic address bounds that define address ranges Rᵢ (for example R1, . . . , R7) at an address space, a decision tree according to the method of the invention is constructed based on the above first, second, third, fourth and fifth rules. The construction is performed by selecting addresses to be compared at each iteration (tree node) while at the same time targeting a low tree depth.

There are two objectives when constructing the decision tree. The first one is to select addresses which require fewer bits to be processed in order to maximize the number of node branches. Second, a node in the decision tree should be branching to sub trees of equal or similar depth, so that the entire tree is substantially balanced.

The above objectives may to some extent contradict each other, since maximizing the number of branches may not necessarily keep the tree balanced and vice versa. Therefore four simple heuristics are proposed, rather than an optimal solution which would possibly have unacceptable complexity and/or would require relatively extensive computational effort.

Apart from these two objectives there are other parameters to be considered pertaining to the implementation of the method of the invention. Some of these parameters are memory bandwidth, possible comparison lengths, number of comparisons in a single iteration, and address alignment restrictions.

Four heuristics are described for constructing a decision tree for use with the method of the invention based on an arbitrary set of address ranges and address bounds. Many more, in addition, can be easily developed by one skilled in the art of software programming who follows the teachings as described above.

Each heuristic uses recursive functions which generate the configuration of a tree node or tree level. Two different approaches can be followed, namely top-down and bottom-up.

A top-down heuristic creates first the root node and then similarly moves to its children and towards the end points (leafs) of the tree.

A bottom-up heuristic constructs first the leaf nodes and subsequently their address bounds are used for the next tree level; this is repeated until the root of the tree is reached.

A heuristic should be tailored for a specific implementation and hence may allow comparisons of only few address lengths or only one or few of their combinations to occur simultaneously.

Two top-down and two bottom-up heuristics are described below related to the specific embodiments which share and omit address parts among address bounds. Different heuristics are required for different compression schemes, which however can be easily developed by one of ordinary skill in the area.

Note that a heuristic which constructs a Range Trie is tailored to a specific implementation of the method. One top-down and one bottom-up heuristic described below allow comparisons of only a single length in parallel, while the other allows comparisons of several combinations. The description of the heuristics follows next:

a) TD-SLC Top-Down Heuristic with Single-Length Parallel Comparisons:

1) Apply the rules of the method, especially: Align addresses, find node common prefixes and zero suffixes to be omitted.

2) Select the longest comparator length out of those that maximize the number of branches, e.g., 8-bits. The tree balance and the number of available comparators are not considered at this point.

3) Consider all addresses (address bounds) in the set to be processed with the above comparison length. Omit address suffixes that cannot be compared (due to the selected longest comparison length) assuming they are equal to zero.

4) Create address ranges (intervals) defined by the above comparisons.

5) Merge neighboring address ranges in a single one until the number of comparisons (defines by the address bounds of the ranges) are reduced to the available comparator resources. Take into account the rules of the method, especially: find common address prefixes and suffixes to be shared. Merging aims at creating address ranges (and thus Range Trie nodes) which contain a balanced number of address bounds. The resulted address ranges are the node branches and their borders the comparisons to perform according to the rules of the method.

6) Recursively repeat for the created children nodes.

7) Terminate when each node contains a single basic address range.

It should be noted that instead of balancing the number of address ranges, other metrics could used to keep the tree balanced, e.g., density of ranges: number of ranges per interval length.

b) TD-VLC Top-Down Heuristic with Variable-Length Parallel Comparisons:

TD-VLC is the TD-SLC as described above in which step 5) is modified as follows:

5′) Merge neighboring sort address ranges and split long address ranges until the number of comparisons is reduced to the number of available resources, creating groups which contain a balanced number of basic address ranges. Splitting is performed by adding a comparison of longer length (achieving better precision). The allowed combinations of comparison lengths should be considered based on the target implementation.

c) BU-SLC Bottom-Up Heuristic with Single-Length Parallel Comparisons:

1) Select the first b addresses Aᵢ>Nₐ (where Nₐ initially is 0) that can be compared at one iteration after applying the rules of the method as far as necessary (e.g., Aᵢ, Aᵢ₊₁, . . . A_{b}; 0≦i≦b). The comparison length should be common to all first b addresses and sufficient in order for the comparison to be equivalent of a full address width comparison. Rules (first until fifth as far as necessary) are also applied here.

2) Set as the upper bound N_{b}, of the address range of the node under creation, any point in the address space where N_{b} ∈ (At,Ab], and t/b=C % (with C indicating a constant number between 0 and 100) such that N_{b} has the longest suffix of 0's. The resulted address range that maps to the node under creation is [Nₐ, N_{b}).

3) Repeat the above starting from the upper bound of the previous group N_{b} until all addresses Aᵢ in the address space are in nodes.

4) Recursively repeat the above steps using as new set of addresses Aᵢ with the borders Nₐ, N_{b} of all the nodes at the previous level.

5) Terminate when all addresses in the list are processed in a single node (i.e. the root node has been reached).

d) BU-VLC Bottom-Up Heuristic with Variable-Length Parallel Comparisons:

BU-VLC is the BU-SLC with a modified step 1. In the BU-VLC the comparison length is variable but it should be within the combinations allowed by the target implementation.

### Range Trie Updates

Most applications using address lookup need to update their set of address ranges frequently. For example, current core routers receive prefix updates about every five minutes. A different update mechanism needs to be employed when the address ranges are described as prefixes or simple intervals. However, in either case, updates may require to insert or delete addresses (keys) that define address ranges. In the method of the present invention this can be easily achieved by updating the affected leaf node or sub-tree performing splits or merges as described in the above heuristics using preferably the Bottom-up approach.

When address ranges are described as intervals, e.g., port ranges in packet classification, then the above described simple address insertion or deletion is sufficient to add or remove an interval. On the other hand, when prefixes are used to describe address ranges the update mechanism needs to store more information in order to keep track of overlapping prefixes and multiple parts of a single prefix. To our advantage however is the fact that the method of the present invention can be mapped one to one with a prior art Range Tree of unlimited memory bandwidth and branches per node and hence the range tree technique of storing and updating prefixes can be followed.

Briefly, in the method of the present invention the prefixes can be stored and updated as in described for a prior art Range Tree in: P. Warkhede, S. Suri, and G. Varghese, “Multiway range trees: scalable ip lookup with fast updates,” Comput. Netw., vol. 44, no. 3, pp. 289-303, 2004.

The main idea is that a prefix that defines an address range can be stored in internal tree nodes rather than only leafs of the tree. Each address bound that defines an address range (described as prefix) border keeps a counter for the number of prefixes that have an endpoint on the address bound. As described by Warhede et al. each node keeps a bitmap of W+1 bits where the i−1 bit indicates whether a prefix of length i is matching. There is a slight difference between the definition of the method of the present invention and the prior art range tree as described by Warhede et al. In the method of the present invention, a comparison reports “less” or “greater-equal” and an prefix “10***” is mapped to the interval [10000, 11000). In the range tree comparators report “less-equal” or “greater” and therefore e.g., the prefix “10***” is mapped to the interval (10111, 10111]. Warhede et al. consider that the address space the prior art range tree is mapped to is (−∞, 2ⁿ], then a prefix is stored at its start address bound and at any node or leaf address bound that is contained in the prefix address range but its parent does not. The method of the present invention, could easily be adjusted to perform comparisons as the prior art range tree, however, this would be less beneficial as this would loose the advantage of long zero suffixes (Rule 3).

From the above example, it can be observed that the method of the present invention maps a prefix to an interval with zero suffix bounds as opposed to suffixes of 1's. Consequently, it is preferable to adjust the prefix storing and updating mechanism as follows without giving away any advantages. The address space of the method of the invention is mapped to is [0, ∞) and prefixes are stored at the endpoint of the prefix and at any node or leaf address bound that is contained in the prefix region but its parent does not.

Alternatively, the address space [0, 2^{W}) could be considered as originally described in this method. Then, a prefix (or a pointer to a prefix) along with its length is stored at every node the address range of which is contained by the prefix, but the address range of its parent node is not contained by the prefix. Each address bound that defines an address range (described as prefix) border keeps a counter for the number of prefixes that have an endpoint on the address bound. When a new prefix is inserted it may be stored in a Range Trie node based on the above condition only if any existing prefix already stored in the node is sorter than the newly inserted. When a prefix is deleted then the prefix that replaces the deleted prefix needs to be provided as input even if it is already stored in the data structure.

A Range Trie according to the method of the present invention can also store a set of address ranges which may overlap with each other. Any set of overlapping address ranges (intervals) can be stored in the Range Trie the same way a set of prefixes is stored as described hereinabove.

It will be apparent to the person skilled in the art that other embodiments of the invention can be conceived and reduced to practice without departing from the true spirit of the invention, the scope of the invention being limited only by the appended claims. The description illustrates the invention and is not intended to limit the invention.

1-31. (canceled)

32. Method for constructing a decision tree for use in address lookup of a requested address in an address space, the address space being arranged as a set of basic address ranges, each basic address range being defined by a lower and an upper bound address;
an address in the address space being represented by a predetermined number of bits;
the method comprising:
arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address; the at least one node having at least two node branches; each node branch mapping to a respective non-overlapping branch address range in the node address range, the at least one node further having at least one node address being defined to divide the node address range in the at least two branch address ranges;
the branch address ranges being defined by the at least one_node address in the node address range;
decomposing each node address in a plurality of address parts, each address part being represented by a respective subset of the predetermined number of bits,
the decomposition for each node address comprising at least one of:
determining from the node address being decomposed one or more address parts that are either a node address suffix of value ‘zero’ or an address part which is common for all addresses in the node address range, said one or more address parts being omissible as an at least one omissible address part when storing in the at least one node;
determining for storing as an at least one common address part from all further remaining address parts, other than the omissible address parts, in the node address being decomposed, the one or more address parts that are common for multiple node addresses in the node address range;
storing the plurality of address parts in the at least one node according to a selection rule,
the selection rule comprising at least one action from a group of actions, the actions comprising:
an action of either
storing the at least one common address part only once in the node,
or—omitting the at least one omissible address part; and
an action of—storing in the node all other address parts as determined in the decomposition step, said all other address parts not being either the at least one common address part or the at least one omissible address part.

33. Method according to claim 32, wherein a union of all branch address ranges in the at least one node is the node address range of the at least one node.

34. Method according to claim 32, wherein the branch address range is the node address range of the node the branch points to.

35. Method according to claim 32, wherein a total number of bits occupied by the address parts stored in the node is less than the total number of bits of the node addresses.

36. Method according to claim 32, wherein a node is arranged for storing address parts of a single node address having two node branches; the single node address having at least one omissible address part.

37. Method according to claim 32, wherein the decision tree is further arranged to comprise at least a bottom level below the top level, nodes in the bottom level being arranged as leaf nodes of the decision tree, each leaf node mapping to one basic address range or a part of one basic address range from the set of basic address ranges, each leaf node storing information related to the respective basic address range it maps to.

38. Method according to claim 37, wherein each node is arranged for storing a prefix or a pointer to a prefix out of a set of prefixes which define address ranges; the prefix being the longest matching prefix of the set of prefixes which contains the node address range.

39. Method according to claim 38, wherein each node which is not a leaf node is further arranged for storing a counter value per node address which counter value is arranged for counting the number of prefixes which have an endpoint at the node address.

40. Method according to claim 37, further comprising:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes.

41. Method according to claim 37, further comprising:
receiving as input the requested address;
determining the basic address range the requested address belongs to, comprising, in each level of the decision tree, starting from a root node in a top level:
for a respective node in the respective level:
reading the address parts stored in the respective node;
subtracting the requested address with a predefined constant value;
comparing at least one address part stored in the respective node in the level with a respective corresponding address part of the subtraction result;
based on the at least one comparison branching to a node of the next level of the decision tree, until the basic address range has been determined when reaching one of the leaf nodes.

42. Method according to claim 32, wherein the at least one omissible address part is a common node prefix determined by the at least one common part for all addresses in the node address range as a common node prefix subset of the predetermined number of bits; the common node prefix subset being omitted from the subset of bits of the address parts stored in the node.

43. Method according to claim 32, wherein the at least one omissible address part represents a suffix of a node address in the node address range; the suffix having value ‘zero’; the at least one omissible address part being omitted from being stored in the node.

44. Method according to claim 32, wherein the at least one common address part is common for two or more node addresses in the node; the at least one common address part being stored only once in the node, and being compared with a corresponding address part of the requested address only once when determining a node branch to be taken.

45. Method according to claim 32, comprising
subtracting a predetermined constant value from the lower and from the upper node bound addresses, from each node address, and from the requested address;
the subtraction preceding the decomposition of each node address.

46. Method according to claim 45, wherein the predetermined constant value is equal to the value of the lower node bound address.

47. Method according to claim 32, comprising further reducing a total number of bits occupied by the address parts stored in the node by applying a compression related technique on the number of bits.

48. Method according to claim 40, wherein results of the comparison are being considered per node address with priority from more significant address parts to less significant address parts; the comparison result of a less significant address part of a node address being considered only if comparison results of the more significant address parts of the node address result in equality;
the method comprising: combining the comparison results per node address so as to define the branch address range to which the requested address belongs,
and consequently branching to the next level as defined by the branch address range.

49. Method according to claim 37, wherein arranging the decision tree comprises:
selecting addresses which are range bounds from the set of basic address ranges, the parts of the selected addresses to be included in a node of the decision tree;
arranging the nodes in the decision tree structure such that
each leaf node of the decision tree points to one basic address range or to a subset of one basic address range from the set of basic address ranges.

50. Method according to claim 49, wherein arranging the decision tree is accomplished by a top-down heuristic, comprising:
selecting addresses the parts of which are to be included in a node, starting from the top level of the decision tree,
subsequently constructing the nodes of next levels in downward direction,
finishing when all leaf nodes point to a basic address range or to a subset of a basic address range of the set of basic address ranges.

51. Method according to claim 49, wherein arranging the decision tree is accomplished by a bottom-up heuristic, comprising:
selecting addresses the parts of which are to be included in a node, starting from the bottom level of the decision tree constructing first the nodes that branch to leaf nodes, each leaf node of the decision tree pointing to a basic address range or to a subset of a address range of the set of basic address ranges;
subsequently constructing nodes of a next level in upward direction along the decision tree;
finishing when a single root node is constructed in the top level.

52. Computer system for constructing a decision tree for use in address lookup of a requested address in an address space,
the address space being arranged as a set of basic address ranges,
each basic address range being defined by a lower and an upper bound address;
an address in the address space being represented by a predetermined number of bits
the computer system comprising a memory and a processor, the processor being coupled to the memory, wherein the processor is arranged for carrying out a method for constructing the decision tree for use in address lookup of the requested address in the address space, comprising:
arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches;
each node branch mapping to a respective non-overlapping branch address range in the node address range, the at least one node further having at least one node address being defined to divide the node address range in the at least two branch address ranges;
the branch address ranges being defined by the at least one node addresses in the node address range;
decomposing each node address in a plurality of address parts, each address part being represented by a respective subset of the predetermined number of bits,
the decomposition for each node address comprising at least one of:
determining from the node address being decomposed one or more address parts that are either a node address suffix of value ‘zero’ or an address part which is common for all addresses in the node address range, said one or more address parts being omissible as an at least one omissible address part when storing in the at least one node; and
determining for storing as an at least one common address part from all further remaining address parts in the node address being decomposed, other than omissible address parts, the one or more address parts that are common for multiple node addresses as an at least one common address part,
storing the plurality of address parts in the at least one node according to a selection rule,
the selection rule comprising at least one action from a group of actions, the actions comprising:
an action of either—storing the at least one common address part only once in the node,
or—omitting the at least one omissible address part;
and
an action of—storing in the node all other address parts as determined in the decomposition step, said all other address parts not being either the at least one common address part or the at least one omissible address part.

53. Computer system according to claim 52, wherein the computer system is arranged for carrying out:
arranging the decision tree to comprise at least a bottom level below the top level, nodes in the bottom level being arranged as leaf nodes of the decision tree, the leaf nodes mapping to one basic address range or a part of one basic address range from the set of basic address ranges, each leaf node storing information related to a respective basic address range it maps to.

54. Computer system according to claim 53, wherein the computer system is arranged for carrying out:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes.

55. Computer system according to claim 54, wherein the computer system is arranged for carrying out:
receiving as input the requested address;
determining the basic address range the requested address belongs to, comprising, in each level of the decision tree, starting from a root node in a top level:
for a respective node in the respective level:
reading the address parts stored in the respective node;
subtracting the requested address with a predefined constant value;
comparing at least one address part stored in the respective node in the level with a respective corresponding address part of the subtraction result;
based on the at least one comparison branching to a node of the next level of the decision tree, until the basic address range has been determined when reaching one of the leaf nodes.

56. Computer system according to claim 54, wherein the processor comprises a plurality of processing units; each processing unit being associated with at least one level of the decision tree and being arranged for carrying out in the associated level of the decision tree computations to compare at least one of the address parts stored in the node of the associated level with a respective corresponding address part of the requested address and subsequently to branch to the node of the next level in downward direction along the decision tree.

57. Computer system according to claim 54, wherein the computer system is one selected from a communication system, a networked router, and a packet switching system.

58. Computer program on a computer-readable medium to be loaded by a computer system according to claim 54, for constructing a decision tree for use in address lookup of a requested address in an address space,
the address space being arranged as a set of basic address ranges,
each basic address range being defined by a lower and an upper bound address;
an address in the address space being represented by a predetermined number of bits;
the computer system comprising a memory and a processor, the processor being coupled to the memory, wherein the computer program product after being loaded allows the processor to carry out:
arranging the decision tree for determining a specific basic address range from the set of basic address ranges to which the requested address belongs,
the decision tree comprising at least one level, the at least one level comprising at least one node;
the at least one node being arranged for mapping to a node address range, the node address range being a node related portion of the address space, the node address range defined by a lower and an upper node bound address;
the at least one node having at least two node branches;
each node branch mapping to a respective non-overlapping branch address range in the node address range, the at least one node further having at least one node address being defined to divide the node address range in the at least two branch address ranges;
the branch address ranges being defined by the at least one node addresses in the node address range;
decomposing each node address in a plurality of address parts, each address part being represented by a respective subset of the predetermined number of bits,
the decomposition for each node address comprising at least one of:
determining from the node address being decomposed one or more address parts that are either a node address suffix of value ‘zero’ or an address part which is common for all addresses in the node address range, said one or more address parts being omissible as an at least one omissible address part when storing in the at least one node;
determining for storing as an at least one common address part from all further remaining address parts in the node address being decomposed, other than the omissible address parts, the one or more address parts that are common for multiple node addresses in the node address range,
storing the plurality of address parts in the at least one node according to a selection rule,
the selection rule comprising at least one action from a group of actions, the actions comprising:
an action of either—storing the at least one common address part only once in the node,
or—omitting the at least one omissible address part; and
an action of—storing in the node all other address parts as determined in the decomposition step, said all other address parts not being either the at least one common address part or the at least one omissible address part.

59. Computer-readable medium being provided with a computer program in accordance with claim 58.

60. Computer system for address lookup of a requested address in an address space by using a decision tree, the decision tree being constructed according to the method of claim 32, the computer system comprising a memory and a processor, the processor being coupled to the memory, wherein the processor is arranged for carrying out:
receiving as input the requested address;
determining the basic address range the requested address belongs to, comprising, in each level of the decision tree, starting from a root node in a top level:
for a respective node in the respective level:
reading the address parts stored in the respective node;
comparing at least one address part stored in the respective node in the level with a respective corresponding address part of the requested address;
based on the at least one comparison branching to a node of the next level of the decision tree, until the basic address range has been determined when reaching one of the leaf nodes.

61. Computer system according to claim 60, wherein the computer system is further arranged for carrying out:
after reading the address parts stored in the respective node, subtracting the requested address with a predefined constant value to obtain a subtraction result;
and substituting the requested address by the subtraction result before said comparing at least one address part stored in the respective node in the level with a respective corresponding address part of the requested address.

62. Computer system according to claim 60, wherein the computer system is one selected from a communication system, a networked router, and a packet switching system.
